(19) United States
(12) Patent Application Publication
(10) Pub. No.: US 2026/0139806 A1
(43) Pub. Date: May 21, 2026

(54) LIGHT-EMITTING DEVICE, HEADLIGHT, AND VEHICLE EQUIPPED WITH SAME

(71) Applicant: NICHIA CORPORATION, Anan-shi (JP)

(72) Inventors: Haruka HINO, Komatsushima-shi (JP); Yukiko SANO, Anan-shi (JP)

(73) Assignee: NICHIA CORPORATION, Anan-shi (JP)

(21) Appl. No.: 19/120,779

(22) PCT Filed: Jul. 24, 2023
(86) PCT No.: PCT/JP2023/026930

§ 371 Date: Feb. 6, 2026

(30) Foreign Application Priority Data
Oct. 14, 2022 (JP) 2022-165217

(51) Int. Cl. F21S 41/176; F21S 41/143

(52) U.S. Cl. CPC F21S 41/176; F21S 41/143

(57) ABSTRACT

A light emitting device comprises: a light emitting element having a light emission peak wavelength in a range of 400 nm or more and 490 nm or less; and a wavelength conversion member including a first fluorescent material having a light emission peak wavelength in a range of 480 nm or more and less than 580 nm and a second fluorescent material having a light emission peak wavelength in a range of 580 nm or more and 680 nm or less and having a composition different from that of the first fluorescent material. The light emitting device emits light having a first luminance ratio Ls/L of 0.9 or less, the first luminance ratio Ls/L being a ratio of a first effective radiance Ls of the light emitted by the light emitting device in consideration of a spectral luminous efficiency curve for photopic vision of humans specified by CIE and the S-cone spectral sensitivity of humans, to a luminance L of the light emitted by the light emitting device in consideration of the spectral luminous efficiency curve for photopic vision of humans. The first fluorescent material comprises a rare earth aluminate fluorescent material having a composition represented by formula (1A).

### TECHNICAL FIELD

The present disclosure relates to a light emitting device, a headlight, and a vehicle equipped with the same.

### BACKGROUND ART

Headlights for road transportation vehicles such as motorcycles and automobiles, and vehicles used for tractor-type construction machines such as ground leveling, transporting, and loading machines, or excavator-type construction machines such as excavating machines use lighting fixtures such as light emitting devices using halogen lamps, high-intensity discharge (HID) lamps, and semiconductor light emitting elements as excitation light sources. For example, one or more headlights for automobiles are symmetrically mounted on the left and right sides of the front end at positions lower than the driver's viewpoint. The headlights have a high beam lighting fixture (headlight for driving) and a low beam lighting fixture (headlight for passing each other), which can be switched between the two. The high beam illuminates a relatively long distance, for example, up to approximately 100 m ahead, while the low beam illuminates a slightly lower and closer area than the high beam, for example, approximately 40 m ahead.

For example, Patent Literature 1 discloses a vehicle headlight including a first lighting fixture unit that is lit in a low beam mode, and a first lighting fixture unit and a second lighting fixture unit that are simultaneously lit in a high beam mode. Patent Literature 1 discloses a first lighting fixture unit using a white light emitting device (LED) that emits light at a correlated color temperature of 4,000 K to 6,500 K as a light source, and a second lighting fixture unit using a metal halide lamp, which is a type of HID lamp, that emits light at a correlated color temperature of 4,000 K to 5,000 K as a light source.

### CITATION LIST

### Patent Literature

Patent Literature 1: Japanese Unexamined Patent Publication No. 2005-141917

### SUMMARY OF THE INVENTION

### Problem to be Solved by the Invention

The light emitted by vehicle headlights may stimulate the vision of drivers of preceding or oncoming vehicles, causing glare that makes them feel uncomfortable and difficult to see objects. Glare is a sensation caused by inappropriate luminance distribution or extreme luminance contrast in the visual field, and is associated with discomfort and reduction in viewing ability (Japanese Industrial Standard (JIS) Z9110). Furthermore, the light emitted by the headlight may cause glare to the driver of the moving vehicle due to reflected light.

Accordingly, aspects of the present disclosure are to provide a light emitting device capable of reducing glare and having improved durability, a headlight, and a vehicle equipped with the same.

### Means for Solving Problem

A first aspect of the present disclosure relates to a light emitting device including: a light emitting element having a light emission peak wavelength in a range of 400 nm or more and 490 nm or less; and a wavelength conversion member including a first fluorescent material having a light emission peak wavelength in a range of 480 nm or more and less than 580 nm and a second fluorescent material having a light emission peak wavelength in a range of 580 nm or more and 680 nm or less and having a composition different from that of the first fluorescent material, wherein the light emitting device emits light having a first luminance ratio Ls/L, as derived from the following formula (1), that is 0.9 or less, wherein the first luminance ratio Ls/L is a ratio of a first effective radiance Ls of the light emitted by the light emitting device in a range of 380 nm or more and 780 nm or less in consideration of a spectral luminous efficiency curve for photopic vision of humans specified by CIE (Commission Internationale de l'Eclairage) and the S-cone spectral sensitivity of humans, to a luminance L of the light emitted by the light emitting device in a range of 380 nm or more and 780 nm or less in consideration of the spectral luminous efficiency curve for photopic vision of humans, and wherein the first fluorescent material contains a rare earth aluminate fluorescent material having a composition represented by the following formula (1A).

$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$

wherein S (λ) represents a spectral radiance of the light emitted by the light emitting device, V (λ) represents a spectral luminous efficiency curve for photopic vision of humans specified by CIE, and Gs (λ) represents the S-cone spectral sensitivity of humans in a wavelength A range of 380 nm or more and 550 nm or less.

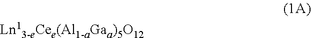

wherein Ln¹ represents at least one element selected from the group consisting of Y, Gd, Tb, and Lu, and a and e satisfy 0≤a≤0.5 and 0.019≤e≤0.2.

A second aspect of the present disclosure relates to a light emitting device including: a light emitting element having a light emission peak wavelength in a range of 400 nm or more and 490 nm or less; and a wavelength conversion member including a first fluorescent material having a light emission peak wavelength in a range of 480 nm or more and less than 580 nm and a second fluorescent material having a light emission peak wavelength in a range of 580 nm or more and 680 nm or less and having a composition different from that of the first fluorescent material, wherein the light emitting device emits light having a second luminance ratio B/A, as derived from the following formula (2), that is 0.104 or less, wherein the second luminance ratio B/A is a ratio of a second effective radiance B of the light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less, and wherein the first fluorescent material contains a rare earth aluminate fluorescent material having a composition represented by the following formula (1A).

$$B / A = \frac{{\int }_{300}^{800} Dc ( λ ) \times S ( λ ) d λ}{{\int }_{300}^{800} S ( λ ) d λ} \qquad ( 2 )$$

wherein S (λ) represents a spectral radiance of the light emitted by the light emitting device, and Dc (λ) denotes a scattering intensity curve, normalized to 1 at a wavelength of 300 nm for Rayleigh scattering.

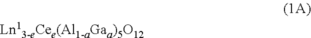

wherein Ln¹ represents at least one element selected from the group consisting of Y, Gd, Tb, and Lu, and a and e satisfy 0≤a≤0.5 and 0.019≤e≤0.2.

A third aspect of the present disclosure relates to a headlight including the light emitting device.

A fourth aspect of the present disclosure relates to a vehicle including the light emitting device or the headlight.

### Effect of the Invention

Certain aspects of the present disclosure provide a light emitting device capable of reducing glare and having improved durability, a headlight, and a vehicle equipped with the same.

### BRIEF DESCRIPTION OF DRAWINGS

FIG. 1A is the S-cone spectral sensitivity Gs (λ) of humans disclosed in Non-Patent Literature 2.

FIG. 1B is a spectral luminous efficiency curve for photopic vision V (λ) of humans, which is specified by CIE, disclosed in Non-Patent Literature 2.

FIG. 1C is a curve corresponding to V_{K} (λ): K=1.260 disclosed in Non-Patent Literature 2, and is an example of spectral luminous sensitivity V_{K} (λ) corresponding to glare.

FIG. 2 is a graph showing an intensity curve Dc (λ) of Rayleigh scattering when a scattering intensity at a wavelength of 300 nm is 1.

FIG. 3A is a schematic plan view showing an exemplary light emitting device.

FIG. 3B is a schematic cross-sectional view showing an exemplary light emitting device.

FIG. 3C is a partially enlarged view of a schematic cross section of an exemplary light emitting device.

FIG. 4 is a diagram showing a horizontal cross-sectional view of an exemplary headlight.

FIG. 5 is a diagram showing a front view of an exemplary headlight.

FIG. 6 is an exemplary graph showing a light emission spectrum of a light emitting device according to Example 1 before a reliability evaluation test.

FIG. 7 is an exemplary graph showing a light emission spectrum of the light emitting device according to Example 1 after the reliability evaluation test.

FIG. 8 is a binarized photograph of the surface of a light-transmissive body in the light emitting device according to Example 1 after the reliability evaluation test.

FIG. 9 is a binarized photograph of the surface of a light-transmissive body in a light emitting device according to Comparative Example 1 after the reliability evaluation test.

### MODE(S) FOR CARRYING OUT THE INVENTION

The embodiments of the present disclosure are hereunder described by reference to the accompanying drawings. The embodiments described below are those exemplifying a light emitting device, a headlight, and a vehicle equipped with the same for the purpose of embodying the technical idea of the present disclosure, and the present disclosure is not limited to the following light emitting device, headlight, and vehicle equipped with the same. In addition, the members described in the claims are by no means limited to members of the embodiments. Especially, unless otherwise specified, any dimensions, materials, shapes, and relative dispositions of the structural members described in the embodiments are not intended to limit the scope of the present disclosure only but are merely explanatory examples. The relationships between color names and chromaticity coordinates, and the relationships between wavelength ranges of light and color names of monochromic light are in accordance with Japanese Industrial Standard JIS Z8110. In the present specification, unless otherwise specified, in the case where plural substances corresponding to each component are present in the composition, the content of each component in the composition refers to a total amount of the plural substances present in the composition. In the present specification, the full width at half maximum refers to a wavelength width at which the light emission intensity is 50% of the light emission intensity at the light emission peak wavelength showing the maximum light emission intensity in the light emission spectrum.

Various light sources such as HID lamps, halogen lamps, and light emitting devices using LEDs are used in vehicle headlights depending on the characteristics such as luminous flux and energy. Differences in light sources result in different levels of glare, which makes humans feel dazzled, and different levels of apparent brightness. For example, the brightness of road surfaces is also affected by the blue light component and the correlated color temperature of the light. Non-Patent Literature 1 discloses an evaluation that humans feel dazzling with LED light sources having a high correlated color temperature of, for example, 6,600 K, regardless of whether they are elderly or non-elderly (Non-Patent Literature 1: “Evaluating Discomfort Glare Using White Light with LEDs of Different Color Temperatures” by Hiroshi Hashimoto et al., Japan Automobile Research Institute, Preventive Safety Research Department, October 2006, Automotive Research, Vol. 28, No. 10, pp. 569-572). The degree of glare that humans feel uncomfortable varies depending on the decrease in human retinal illumination and the deterioration of rod cells, and it may also vary depending on the age of humans. Among cone cells, which are photoreceptive cells present in the human retina, S-cone cells are photoreactive to short-wavelength light. The S-cone cells have a peak wavelength of sensitivity around 440 nm. Non-Patent Literature 2 discloses the following formula (3) for a novel spectral luminous sensitivity V_{K} (λ) corresponding to glare, in consideration of the spectral luminous efficiency curve for photopic vision V (λ) of humans used in the side optical system of the CIE 1931 color system and the S-cone spectral sensitivity Gs (λ) of humans at a wavelength of A (Non-Patent Literature 2: “Research on the Effect of Spectral Distribution of Headlamp Light Source on Discomfort Glare” by Shoji Kobayashi, et al., Preprint of Academic Lecture Meeting of Society of Automotive Engineers of Japan, No. 5 to 10, pp. 9-14). In the present specification, spectral radiance is synonymous with spectral distribution.

$${V}_{K} ( λ ) = 1.26 \times Gs ( λ ) + V ( λ ) \qquad ( 3 )$$

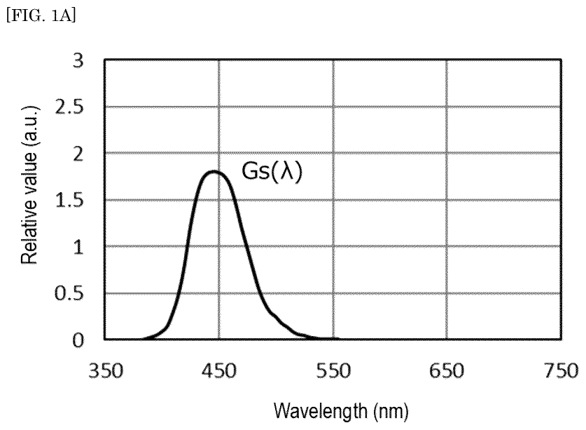

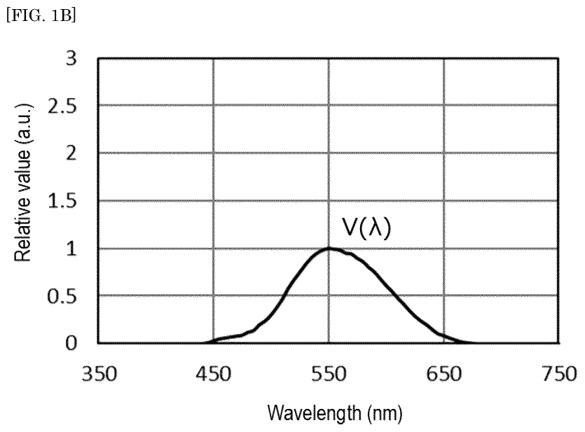

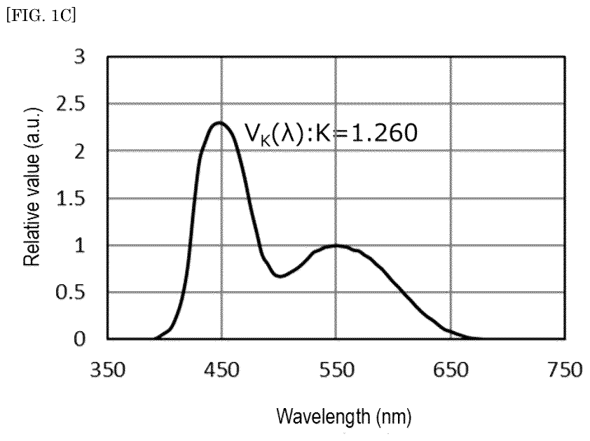

FIG. 1A shows an S-cone spectral sensitivity Gs (λ) of humans disclosed in Non-Patent Literature 2. Based on FIG. 1A, the numerical value of the S-cone spectral sensitivity Gs (λ) of humans can be derived. The S-cone spectral sensitivity Gs (λ) of humans has a spectral sensitivity peak in a range of 380 nm or more and 550 nm or less. FIG. 1B shows a spectral luminous efficiency curve for photopic vision V (λ) of humans, which is specified by CIE, disclosed in Non-Patent Literature 2. The relative values shown in FIGS. 1A to 1C are values relative to the peak top of the spectral luminous efficiency curve for photopic vision V (λ) of humans specified by CIE being 1. Based on FIG. 1B, the numerical value of the spectral luminous efficiency curve for photopic vision V (λ) of humans specified by CIE can be derived. FIG. 1C shows a curve corresponding to VR (λ): K=1.260 disclosed in Non-Patent Literature 2, and is an example of spectral luminous sensitivity V_{K} (λ) corresponding to glare, in consideration of the spectral luminous efficiency curve for photopic vision of humans specified by CIE and the S-cone spectral sensitivity of humans. K represents a coefficient that determines the percentage contribution of the S-cone spectral sensitivity Gs (λ) of humans. The coefficient K for halogen lamps is 1.260.

The luminance L of the light emitted by the light emitting device is derived by the following formula (4). The luminance L of the light emitted by the light emitting device is an integrated value of the spectral radiance S (λ) of the light emitting device in a range of 380 nm or more and 780 nm or less and the spectral luminous efficiency curve for photopic vision V (λ) of humans specified by CIE.

$$L = {\int }_{380}^{780} S ( λ ) \times V ( λ ) d λ \qquad ( 4 )$$

The first effective radiance Ls of the light emitted by the light emitting device is derived by the following formula (5). The first effective radiance Ls of the light emitted by the light emitting device is a numerical value obtained by dividing the integrated value of the spectral radiance S (λ) of the light emitting device in the range of 380 nm or more and 780 nm or less and the human spectral luminous sensitivity VR (λ) (=K·Gs(λ)+V(λ)) corresponding to glare represented by the formula (3), by 2.3 that is the peak top of V_{K} (λ) derived by the formula (3) using the coefficient K (=1.260) in the case of halogen lamps.

$$Ls = \frac{1}{2.3} {\int }_{380}^{780} S ( λ ) \{ 1.26 \times Gs ( λ ) + V ( λ ) \} d λ \qquad ( 5 )$$

The first luminance ratio Ls/L of the light emitted by the light emitting device is a ratio of the first effective radiance Ls of the light emitted by the light emitting device in consideration of the spectral luminous efficiency curve for photopic vision of humans specified by CIE and the S-cone spectral sensitivity of humans, to the luminance L of the light emitted by the light emitting device in consideration of the spectral luminous efficiency curve for photopic vision of humans specified by CIE. The first luminance ratio Ls/L represents the degree of glare reduction of the light emitted by the light emitting device.

The light emitting device according to the first embodiment includes a light emitting element having a light emission peak wavelength in a range of 400 nm or more and 490 nm or less, a first fluorescent material having a light emission peak wavelength in a range of 480 nm or more and less than 580 nm, and a second fluorescent material having a light emission peak wavelength in a range of 580 nm or more and 680 nm or less and having a composition different from that of the first fluorescent material. The light emitting device emits light having a first luminance ratio Ls/L of 0.9 or less derived from the following formula (1).

$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$

wherein S (λ) represents a spectral radiance of the light emitted by the light emitting device, V (λ) represents a spectral luminous efficiency curve for photopic vision of humans specified by CIE, and Gs (λ) represents the S-cone spectral sensitivity of humans in a wavelength (λ nm) range of 380 nm or more and 550 nm or less.

When the first luminance ratio Ls/L of the light emitted by the light emitting device is 0.9 or less, the light emitting device can emit light with reduced glare. When the first luminance ratio Ls/L of the light emitted by the light emitting device is more than 0.9, it is close to the luminance L of the light emitted by the light emitting device, which does not take into account the S-cone spectral sensitivity of humans, and glare is not reduced. In order to reduce glare that humans feel uncomfortable, the first luminance ratio Ls/L of the light emitted by the light emitting device is preferably 0.85 or less, more preferably 0.83 or less, even more preferably 0.80 or less, and may be 0.7 or less. Considering the S-cone spectral sensitivity of humans, the first luminance ratio Ls/L of the light emitted by the light emitting device may be 0.1 or more, may be 0.2 or more, preferably 0.3 or more, more preferably 0.4 or more, and even more preferably 0.5 or more.

The light emitting device that emits light having a first luminance ratio Ls/L of 0.9 or less preferably emits light having a second luminance ratio A/B of 0.104 or less described below. The light emitting device that emits light having a first luminance ratio Ls/L of 0.9 or less and a second luminance ratio A/B of 0.104 or less described below enables light to reach a long distance while reducing glare. The light emitting device according to the first embodiment, which enables light to reach a long distance while reducing glare, can be used for a headlight and a vehicle equipped with the same. The headlight using the light emitting device according to the first embodiment and the vehicle equipped with the headlight enable light to reach a long distance while reducing glare of the light emitted by the headlight and the vehicle.

In the light emitting device according to the first embodiment, the first fluorescent material contains a rare earth aluminate fluorescent material having a composition represented by the following formula (1A).

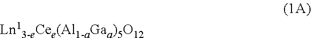

wherein Ln¹ represents at least one element selected from the group consisting of Y, Gd, Tb, and Lu, and a and e satisfy 0≤a≤0.5 and 0.019≤e≤0.2.

In the rare earth aluminate fluorescent material represented by the formula (1A), the parameter e representing the molar ratio of Ce as an activating element in the composition is large as 0.019 or more and 0.2 or less (0.019≤e≤0.2), so that the content of the first fluorescent material contained in the light emitting device can be reduced, and even when the content of the first fluorescent material is small, the light emitting device can emit light having a desired color. In addition, because the parameter e representing the molar ratio of Ce as an activating element in the composition of the rare earth aluminate fluorescent material represented by the formula (1A) is large as 0.019 or more and 0.2 or less (0.019≤e≤0.2), the content of the first fluorescent material contained in the light emitting device can be reduced, the heat generated by the fluorescent material can be reduced, deterioration of the light emitting device, such as breakage or cracking, due to heat can be suppressed, and the durability of the light emitting device can be improved.

In the formula (1A), the parameter e representing the molar ratio of Ce as an activating element may be in a range of 0.019 or more and 0.118 or less (0.019≤e≤0.118), or may be in a range of 0.019 or more and 0.115 or less (0.019≤e≤0.115). In the formula (1A), the parameter a, which represents the molar ratio of Ga by multiplying by 5, may be in a range of 0 or more and 0.45 or less (0≤a≤0.45), or may be in a range of 0 or more and 0.40 or less (0≤a≤0.40).

The light emitting device according to the second embodiment includes a light emitting element having a light emission peak wavelength in a range of 440 nm or more and 490 nm or less, a first fluorescent material having a light emission peak wavelength in a range of 480 nm or more and less than 580 nm, and a second fluorescent material having a light emission peak wavelength in a range of 580 nm or more and 680 nm or less and having a composition different from that of the first fluorescent material. The light emitting device emits light having a second luminance ratio B/A of 0.104 or less derived from the following formula (2), which is a ratio of a second effective radiance B of the light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less.

$$B / A = \frac{{\int }_{300}^{800} Dc ( λ ) \times S ( λ ) d λ}{{\int }_{300}^{800} S ( λ ) d λ} \qquad ( 2 )$$

wherein S (λ) represents a spectral radiance of the light emitted by the light emitting device, and Dc (λ) denotes a scattering intensity curve, normalized to 1 at a wavelength of 300 nm for Rayleigh scattering.

Light scattering caused by the interaction of light and fine particles is determined by the relative relationship between the wavelength λ of the light and the size D of the fine particles. The size D of fine particles contained in the air is much smaller than the wavelength λ of light. Rayleigh scattering is the scattering of the light caused by particles that are smaller in size than the wavelength of the light. In the air, the shorter the wavelength of light, the more easily the light is scattered. Suppression of light scattering enables light to reach a long distance. Light emitting devices that enable light to reach a long distance can be suitably used for high-beam mode headlights that illuminate a relatively distant area, such as approximately 100 m ahead. The light emitting device according to the second embodiment suppresses scattering and enables light to reach a relatively long distance. A headlight using the light emitting device according to the second embodiment and a vehicle equipped with the headlight enable light to reach a relatively long distance.

The radiance A of the light emitted by the light emitting device is derived by the following formula (6). The radiance A of the light emitted by the light emitting device is an integrated value of the spectral radiance S (λ) of the light emitting device in a range of 300 nm or more and 800 nm or less.

$$A = {\int }_{300}^{800} S ( λ ) d λ \qquad ( 6 )$$

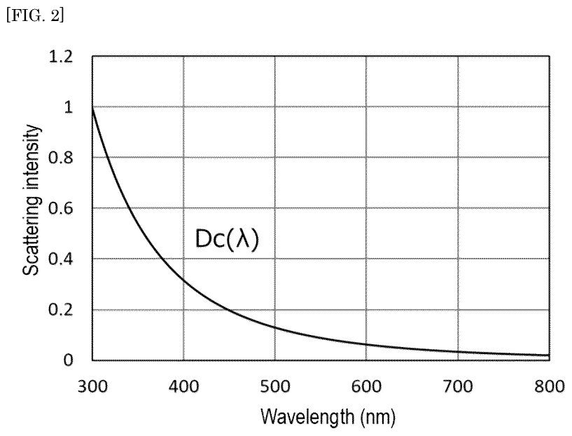

FIG. 2 shows a scattering intensity curve Dc (λ) for wavelengths when a scattering intensity of Rayleigh scattering at a wavelength of 300 nm is 1.

The second effective radiance B of the light emitted by the light emitting device is derived by the following formula (7). The second effective radiance B of the light emitted by the light emitting device is an integrated value of the scattering intensity curve Dc (λ) and the spectral radiance S (λ) of the light emitting device in a range of 300 nm or more and 800 nm or less.

$$B = {\int }_{300}^{800} Dc ( λ ) \times S ( λ ) d λ \qquad ( 7 )$$

The second luminance ratio B/A of the light emitted by the light emitting device is a ratio of the second effective radiance B of the light emitted by the light emitting device in a range of 300 nm or more and 800 nm or less in consideration of the scattering intensity curve for wavelengths when the scattering intensity of Rayleigh scattering at a wavelength of 300 nm is 1, to the radiance A of the light emitted by the light emitting device in a range of 300 nm or more and 800 nm or less. The second luminance ratio B/A represents the degree of scattering of the light emitted by the light emitting device.

When the second luminance ratio B/A of the light emitted by the light emitting device is 0.104 or less, the light emitting device can emit light that is suppressed in scattering and reaches a relatively long distance. When the second luminance ratio B/A of the light emitted by the light emitting device is more than 0.104, it is close to the radiance A of the light emitted by the light emitting device, which does not take into account Rayleigh scattering. In order to emit light that is suppressed in scattering and reaches a relatively long distance, the second luminance ratio B/A of the light emitted by the light emitting device is preferably 0.102 or less, more preferably 0.100 or less, even more preferably 0.099 or less, still more preferably 0.098 or less, still more preferably 0.090 or less, and particularly preferably 0.085 or less. In order to suppress light scattering, the second luminance ratio B/A of the light emitted by the light emitting device is preferably 0.104 or less and a small numerical value; however, if the second luminance ratio B/A of the light emitted by the light emitting device is too small, the spectral radiance becomes small, and it may be difficult for the light to reach a relatively long distance. Considering Rayleigh scattering, the second luminance ratio B/A of the light emitted by the light emitting device may be 0.01 or more, may be 0.02 or more, preferably 0.03 or more, more preferably 0.04 or more, and even more preferably 0.05 or more.

The light emitting device that emits light having a second luminance ratio B/A of 0.104 or less preferably emits light having a first luminance ratio Ls/L of 0.9 or less described above. The light emitting device that emits light having a second luminance ratio A/B of 0.104 or less and a first luminance ratio Ls/L of 0.9 or less enables light to reach a relatively long distance and also reduces glare.

In the light emitting device according to the second embodiment, the first fluorescent material contains a rare earth aluminate fluorescent material having a composition represented by the formula (1A). In the formula (1A), the parameter e representing the molar ratio of Ce as an activating element may be in a range of 0.019 or more and 0.118 or less (0.019≤e≤0.118), or may be in a range of 0.019 or more and 0.115 or less (0.019≤e≤0.115). In the rare earth aluminate fluorescent material represented by the formula (1A), the parameter e representing the molar ratio of Ce as an activating element in the composition is large as 0.019 or more and 0.2 or less (0.019≤e≤0.2), so that the content of the first fluorescent material contained in the light emitting device can be reduced, and even when the content of the first fluorescent material is small, the light emitting device can emit light having a desired color. In addition, because the parameter e representing the molar ratio of Ce as an activating element in the composition of the rare earth aluminate fluorescent material represented by the formula (1A) is large, the content of the first fluorescent material contained in the light emitting device can be reduced, the heat generated by the fluorescent material can be reduced, deterioration of the light emitting device due to heat can be suppressed, and the durability of the light emitting device can be improved.

The following describes a light emitting device that emits light having a first luminance ratio Ls/L of 0.9 or less and/or a light emitting device that emits light having a second luminance ratio B/A of 0.104 or less. The light emitting device that emits light having a first luminance ratio Ls/L of 0.9 or less and the light emitting device that emits light having a second luminance ratio B/A of 0.104 or less preferably have the same range of correlated color temperatures, and they may be light emitting devices of the same embodiment using the same members.

The light emitting device preferably emits light having a correlated color temperature of 1,800 K or more and 5,000 K or less, more preferably 2,000 K or more and 5,000 K or less. A lower correlated color temperature of light emitted by the light emitting device included in, for example, a vehicle headlight reduces glare that is perceived as dazzling by people such as drivers of preceding vehicles, oncoming vehicles, and the driving vehicle itself.

### Light Emitting Element

The light emitting element has a light emission peak wavelength in a range of 400 nm or more and 490 nm or less. The light emission peak wavelength of the light emitting element is preferably in a range of 420 nm or more and 480 nm or less, and may be in a range of 440 nm or more and 460 nm or less. Because at least a part of the light emitted by the light emitting element is used as excitation light for a first fluorescent material and a second fluorescent material, it is preferable to have a light emission peak wavelength that easily excites these fluorescent materials. The light emitting element has a full width at half maximum of the light emission spectrum that is preferably 30 nm or less, more preferably 25 nm or less, and even more preferably 20 nm or less. The light emitting element preferably uses, for example, a semiconductor light emitting element using a nitride-based semiconductor. With this configuration, a stable light emitting device having high efficiency, high input-output linearity, and high resistance to mechanical impacts, can be obtained.

### First Fluorescent Material

The first fluorescent material is excited by the light emitted by the light emitting element having a light emission peak wavelength in a range of 400 nm or more and 490 nm or less to emit light having a light emission peak wavelength in a range of 480 nm or more and less than 580 nm. The first fluorescent material preferably has a full width at half maximum of the light emission spectrum in a range of 90 nm or more and 125 nm or less, and the full width at half maximum may be in a range of 100 nm or more and 124 nm or less, or may be in a range of 110 nm or more and 123 nm or less. When the first fluorescent material has a light emission peak wavelength in the range of 480 nm or more and less than 580 nm, the excitation light emitted by the light emitting element is wavelength-converted, and the light emitting device emits mixed color light of the light emitted by the light emitting element and the light of which the wavelength is converted by the first fluorescent material and the second fluorescent material.

The first fluorescent material contains a rare earth aluminate fluorescent material having a composition represented by the formula (1A), and preferably contains at least one selected from the group consisting of a first nitride fluorescent material having a composition represented by the following formula (1B).

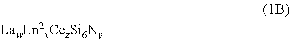

wherein Ln² necessary includes at least one selected from the group consisting of Y and Gd, and may include at least one selected from the group consisting of Sc and Lu, the total of Y and Gd included in Ln² is 90 mol % or more relative to the Ln² elements included in 1 mol of the composition being 100 mol %, and w, x, y, and z satisfy 1.2≤w≤2.2, 0.5≤x≤1.2, 10≤y≤12, 0.5≤z≤1.2, 1.80<w+x<2.40, and 2.9≤w+x+z≤3.1.

The first fluorescent material may contain at least one fluorescent material selected from the group consisting of an alkaline earth metal aluminate fluorescent material and an alkaline earth metal halosilicate fluorescent material. The alkaline earth metal aluminate fluorescent material is, for example, a fluorescent material containing at least strontium and activated with europium, and has a composition represented by, for example, the following formula (1C). The alkaline earth metal halosilicate fluorescent material is, for example, a fluorescent material containing at least calcium and chlorine and activated with europium, and has a composition represented by, for example, the following formula (1D).

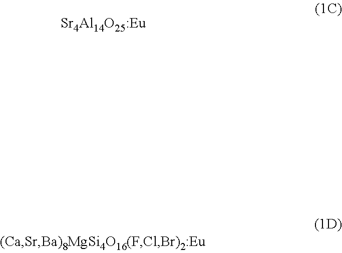

In the formula (1C), a part of Sr may be substituted with at least one element selected from the group consisting of Mg, Ca, Ba, and Zn.

The alkaline earth metal aluminate fluorescent material having a composition represented by the formula (1C) and the alkaline earth metal halosilicate fluorescent material having a composition represented by the formula (1D) each have a light emission peak wavelength in a range of 480 nm or more and less than 520 nm, preferably in a range of 485 nm or more and 515 nm or less.

The alkaline earth metal aluminate fluorescent material having a composition represented by the formula (1C) and the alkaline earth metal halosilicate fluorescent material having a composition represented by the formula (1D) each have a full width at half maximum of, for example, 30 nm or more, preferably 40 nm or more, and more preferably 50 nm or more; and, for example, 80 nm or less, preferably 70 nm or less, in the light emission spectrum.

In the present specification, in the formula representing a composition of a fluorescent material, a part before the colon (:) represents a host crystal and the molar ratio of each element in 1 mol of the composition of the fluorescent material, and a part after the colon (:) represents an activating element. In the present specification, plural elements sectioned by commas (,) in the formula representing a composition of a fluorescent material mean that at least one of these plural elements is contained in the composition, and two or more of these plural elements may be contained in combination.

The first fluorescent material may contain at least one fluorescent material selected from the group consisting of a β-SiAlON fluorescent material, a first sulfide fluorescent material, a scandium-based fluorescent material, an alkaline earth metal silicate fluorescent material, and a lanthanide-based nitride fluorescent material. The β-SiAlON fluorescent material has a composition represented by, for example, the following formula (1E). The first sulfide fluorescent material has a composition represented by, for example, the following formula (1F). The scandium-based fluorescent material has a composition represented by, for example, the following formula (1G). The alkaline earth metal silicate fluorescent material has a composition represented by, for example, the following formula (1H) or a composition represented by, for example, the following formula (1J). The lanthanide-based nitride fluorescent material has a composition represented by, for example, the following formula (1K).

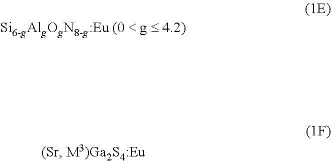

wherein M³ represents at least one element selected from the group consisting of Be, Mg, Ca, Ba, and Zn.

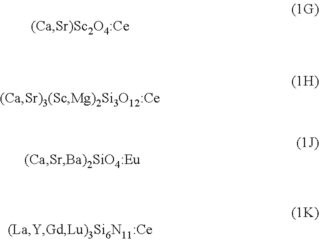

The β-SiAlON fluorescent material, the first sulfide fluorescent material, the scandium-based fluorescent material, the alkaline earth metal silicate fluorescent material, and the lanthanide-based nitride fluorescent material each have a light emission peak wavelength in a range of 520 nm or more and less than 580 nm, preferably in a range of 525 nm or more and 565 nm or less. The β-SiAlON fluorescent material, the first sulfide fluorescent material, the scandium-based fluorescent material, the alkaline earth metal silicate fluorescent material, and the lanthanide-based nitride fluorescent material each have a full width at half maximum of, for example, 20 nm or more, preferably 30 nm or more; and, for example, 120 nm or less, preferably 115 nm or less, in the light emission spectrum.

The first fluorescent material may contain at least one fluorescent material selected from the group consisting of a rare earth aluminate fluorescent material having a composition represented by the formula (1A), a first nitride fluorescent material having a composition represented by the formula (1B), an alkaline earth metal aluminate fluorescent material having a composition represented by the formula (1C), an alkaline earth metal halosilicate fluorescent material having a composition represented by the formula (1D), a β-SiAlON fluorescent material having a composition represented by the formula (1E), a first sulfide fluorescent material having a composition represented by the formula (1F), a scandium-based fluorescent material having a composition represented by the formula (1G), an alkaline earth metal silicate fluorescent material having a composition represented by the formula (1H), an alkaline earth metal silicate fluorescent material having a composition represented by the formula (1J), and a lanthanide-based nitride fluorescent material having a composition represented by the formula (1K). The first fluorescent material may contain at least one fluorescent material having a composition represented by the formula (1A) alone, or may contain two or more fluorescent materials.

### Second Fluorescent Material

The second fluorescent material is excited by the light emitted by the light emitting element having a light emission peak wavelength in a range of 400 nm or more and 490 nm or less to emit light having a light emission peak wavelength in a range of 580 nm or more and 680 nm or less, and has a composition different from that of the first fluorescent material. The second fluorescent material preferably has a full width at half maximum in a range of 3 nm or more and 15 nm or less in the light emission spectrum. Such a second fluorescent material preferably contains, for example, a fluoride fluorescent material having a composition represented by the following formula (2C) or a fluoride fluorescent material having a composition represented by the following formula (2C′). Alternatively, the second fluorescent material preferably has a full width at half maximum in a range of 60 nm or more and 125 nm or less in the light emission spectrum. Such a second fluorescent material preferably contains, for example, a second nitride fluorescent material having a composition represented by the following formula (2A), a third nitride fluorescent material having a composition represented by the following formula (2B), or an α-SiAlON fluorescent material having a composition represented by the following formula (2G). With the second fluorescent material, the excitation light emitted by the light emitting element is wavelength-converted, and the light emitting device emits mixed color light of the light emitted by the light emitting element and the light of which the wavelength is converted by the first fluorescent material and the second fluorescent material.

The second fluorescent material preferably contains at least one selected from the group consisting of a second nitride fluorescent material having a composition represented by the following formula (2A), a third nitride fluorescent material having a composition represented by the following formula (2B), a fluoride fluorescent material having a composition represented by the following formula (2C), a fluoride fluorescent material having a composition represented by the following formula (2C′), which is different in composition from the following formula (2C), and an α-SiAlON fluorescent material having a composition represented by the following formula (2G). In the present specification, the second nitride fluorescent material having a composition represented by the following formula (2A) may be referred to as a BSESN fluorescent material, and the third nitride fluorescent material having a composition represented by the following formula (2B) may be referred to as a SCASN fluorescent material.

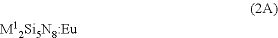

wherein M¹ represents an alkaline earth metal element containing at least one selected from the group consisting of Ca, Sr, and Ba.

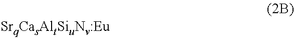

wherein q, s, t, u, and v satisfy 0≤q<1, 0<s≤1, q+s≤1, 0.9≤t≤1.1, 0.9≤u≤1.1, and 2.5≤v≤3.5.

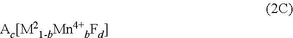

wherein A includes at least one selected from the group consisting of K⁺, Li⁺, Na⁺, Rb⁺, Cs⁺, and NH₄⁺, of which K⁺ is preferred; M² includes at least one element selected from the group consisting of Group 4 elements and Group 14 elements, of which Si and Ge are preferred; b satisfies 0<b<0.2; c represents an absolute value of the charge of [M²_{1-b}Mn⁴⁺_{b}F_{d}] ions; and d satisfies 5<d<7.

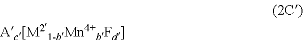

wherein A′ includes at least one selected from the group consisting of K⁺, Li⁺, Nat, Rb⁺, Cs⁺, and NH₄⁺, of which K⁺ is preferred; M^{2′} includes at least one element selected from the group consisting of Group 4 elements, Group 13 elements, and Group 14 elements, of which Si and Al are preferred; b′ satisfies 0<b′<0.2; c′ represents an absolute value of the charge of [M^{2′}_{1-b′}Mn⁴⁺_{b′}F_{d′}] ions; and d′ satisfies 5<d′<7.

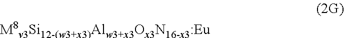

wherein M⁸ includes at least one element selected from the group consisting of Li, Mg, Ca, Sr, Y, and lanthanoid elements (excluding La and Ce); and v3, w3, and x3 satisfy 0<v3≤2.0, 2.0≤w3≤6.0, and 0≤x3≤1.0.

The second fluorescent material may contain at least one fluorescent material selected from the group consisting of a fluorogermanate fluorescent material, a fourth nitride fluorescent material, and a second sulfide fluorescent material. The fluorogermanate fluorescent material has a composition represented by, for example, the following formula (2D). The fourth nitride fluorescent material has a composition represented by, for example, the following formula (2E). The second sulfide fluorescent material has a composition represented by, for example, the following formula (2F).

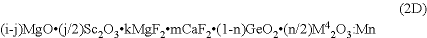

wherein M⁴ represents at least one selected from the group consisting of Al, Ga, and In; and i, j, k, m, n, and z satisfy 2≤i≤4, 0≤j<0.5, 0<k<1.5, 0≤m<1.5, and 0≤n<0.5.

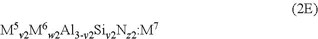

wherein M⁵ represents at least one element selected from the group consisting of Ca, Sr, Ba, and Mg; M⁶ represents at least one element selected from the group consisting of Li, Na, and K; M″ represents at least one element selected from the group consisting of Eu, Ce, Tb, and Mn; and v2, w2, y2, and z2 satisfy 0.80≤v2≤1.05, 0.80≤w2≤1.05, 0≤y2≤0.5, and 3.0≤z2≤5.0.

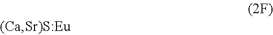

The fluorogermanate fluorescent material having a composition represented by the formula (2D) may have a composition represented by the following formula (2d).

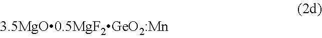

The fourth nitride fluorescent material having a composition represented by the formula (2E) may have a composition represented by the following formula (2e).

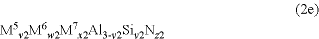

wherein M⁵, M⁶, and M⁷ are synonymous with M⁵, M⁶, and M⁷ in the formula (2E), respectively, and are each at least one element selected from the group consisting of Ce, Tb, and Mn; v2, w2, y2, and z2 are synonymous with v2, w2, y2, and z2 in the formula (2E), respectively; and x2 satisfies 0.001<x2≤0.1.

The fluorogermanate fluorescent material, the fourth nitride fluorescent material, and the second sulfide fluorescent material each have a light emission peak wavelength in a range of 580 nm or more and 680 nm or less, preferably in a range of 600 nm or more and 630 nm or less. The fluorogermanate fluorescent material, the fourth nitride fluorescent material, and the second sulfide fluorescent material each have a full width at half maximum of, for example, 5 nm or more and 100 nm or less, preferably 6 nm or more and 90 nm or less, in the light emission spectrum.

The second fluorescent material preferably contains at least one selected from the group consisting of a second nitride fluorescent material having a composition represented by the formula (2A), a third nitride fluorescent material having a composition represented by the formula (2B), a fluoride fluorescent material having a composition represented by the formula (2C), a fluoride fluorescent material represented by the formula (2C′), a fluorogermanate fluorescent material having a composition represented by the formula (2D), a fourth nitride fluorescent material having a composition represented by the formula (2E), a second sulfide fluorescent material having a composition represented by the formula (2F), and an α-SiAlON fluorescent material having a composition represented by the formula (2G). The second fluorescent material may contain at least one fluorescent material alone, and may contain two or more fluorescent materials.

It is further preferred for the second fluorescent material to contain at least one selected from the group consisting of a second nitride fluorescent material (BSESN fluorescent material) having a composition represented by the formula (2A), a third nitride fluorescent material (SCASN fluorescent material) having a composition represented by the formula (2B), and an α-SiAlON fluorescent material having a composition represented by the formula (2G). The second fluorescent material, which contains at least one selected from the group consisting of the BSESN fluorescent material, the SCASN fluorescent material, and the α-SiAlON fluorescent material, has good temperature characteristics and little change in light emission energy due to changes in temperature. For example, a light emitting device including a wavelength conversion member containing a first fluorescent material and a second fluorescent material both of which have good temperature characteristics has a small change rate of the first luminance ratio Ls/L while the first luminance ratio Ls/L is maintained at 0.9 or less even when the light emitting device is used in, for example, a cold atmosphere of −40° C. or in a hot temperature atmosphere of higher than 100° C., and can be less affected by the ambient temperature of the use environment, thereby emitting light with reduced glare.

The first fluorescent material contains a rare earth aluminate fluorescent material having a composition represented by the formula (1A) and, the second fluorescent material contains at least one selected from the group consisting of the BSESN fluorescent material, the SCASN fluorescent material, and the α-SiAlON fluorescent material, Even if the temperature of the use environment of the light emitting device changes, the light emitting device capable of emitting light with a small change rate of the first luminance ratio Ls/L while maintaining the first luminance ratio Ls/L at 0.9 or less may have good temperature characteristics.

The light emitting device including a wavelength conversion member containing, as a first fluorescent material, a rare earth aluminate fluorescent material having a composition represented by the formula (1A) and, as a second fluorescent material, at least one selected from the group consisting of the BSESN fluorescent material, the SCASN fluorescent material, and the α-SiAlON fluorescent material, and the first fluorescent material and the second fluorescent material have good temperature characteristics. Thus the light emitting device has a small change rate of the second luminance ratio B/A while the second luminance ratio B/A is maintained at 0.104 or less, and can be less affected by the ambient temperature of the use environment, and therefore emits light that is suppressed in scattering and reaches a relatively long distance. Even if the temperature of the use environment of the light emitting device changes, the light emitting device capable of emitting light with a small change rate of the second luminance ratio B/A while maintaining the second luminance ratio B/A at 0.104 or less may have good temperature characteristics.

The fluorescent material including the first fluorescent material and the second fluorescent material preferably has an average particle diameter, as measured according to a Fisher Sub-Sieve Sizer (hereinafter also referred to as “FSSS”) method, in a range of 5 μm or more and 40 μm or less, more preferably in a range of 6 μm or more and 35 μm or less, and even more preferably in a range of 7 μm or more and 30 μm or less. When the average particle diameter of the fluorescent material is in the range of 5 μm or more and 40 μm or less, the fluorescent material efficiently absorbs light emitted by the excitation light source to convert the wavelength, so that the light emitting device can emit light with reduced glare or light that is suppressed in light scattering and reaches a relatively long distance.

The rare earth aluminate fluorescent material having a composition represented by the formula (1A) preferably has an average particle diameter, as measured by the FSSS method, in a range of 15 μm or more and 40 μm or less, more preferably in a range of 16 μm or more and 35 μm or less, and even more preferably in a range of 17 μm or more and 30 μm or less. When the rare earth aluminate fluorescent material having a composition represented by the formula (1A) has a relatively large average particle diameter, as measured by the FSSS method, in the range of 15 μm or more and 40 μm or less, the content of the first fluorescent material contained in the light emitting device can be reduced, and even when the content of the first fluorescent material is small, the light emitting device can emit light having a desired color.

### Light Emitting Device

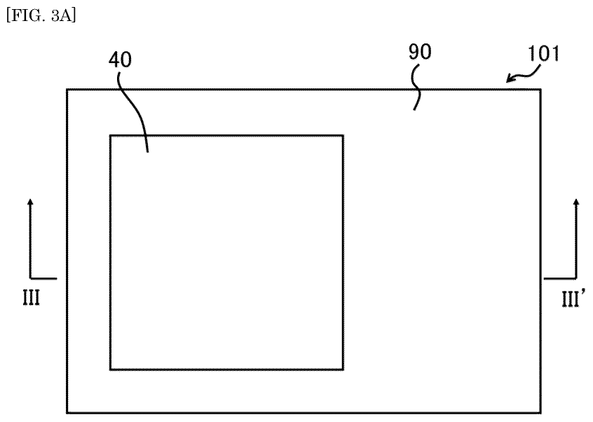

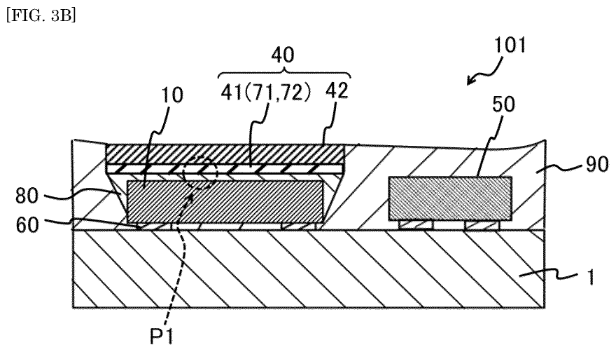

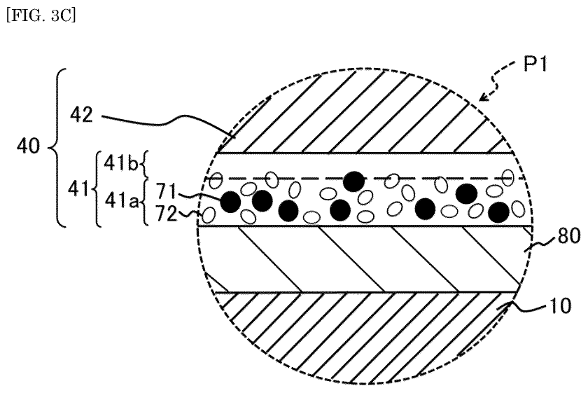

The following describes a form of the light emitting device. FIG. 3A shows an exemplary light emitting device, which is a schematic plan view of a light emitting device 101. FIG. 3B is a schematic cross-sectional view of the III-III′ line of the light emitting device 101 shown in FIG. 3A. The light emitting device 101 includes a light emitting element 10 having a light emission peak wavelength in a range of 400 nm or more and 490 nm or less, and a wavelength conversion member 40 including a wavelength conversion body 41 containing a first fluorescent material 71 and a second fluorescent material 72 that are excited by the light emitted by the light emitting element 10 and emit light, and a light-transmissive body 42 on which the wavelength conversion body 41 is disposed. The light emitting element 10 is flip-chip mounted on a substrate 1 via bumps that are conductive members 60. The wavelength conversion body 31 of the wavelength conversion member 40 is disposed on the light emitting surface of the light emitting element 10 via an adhesive layer 80. The lateral surfaces of the light emitting element 10 and the wavelength conversion member 40 are covered with a covering member 90 that reflects light. The wavelength conversion body 41 includes a first fluorescent material 71 having a light emission peak wavelength in a range of 480 nm or more and less than 580 nm, and a second fluorescent material 72 having a light emission peak wavelength in a range of 580 nm or more and 680 nm or less and having a composition different from that of the first fluorescent material 71, which are excited by the light emitted by the light emitting element 10. The light emitting element 10 receives electric power from the outside of the light emitting device 101 via a wiring and the conductive members 60 formed on the substrate 1, thereby enabling the light emitting device 101 to emit light. The light emitting device 101 may include a semiconductor element 50 such as a protective element, for preventing the light emitting element 10 from being broken by applying an excessive voltage. The covering member 90 is provided so as to cover, for example, the semiconductor element 50. The following describes each member used in the light emitting device. For the details, for example, the disclosure of Japanese Unexamined Patent Publication No. 2014-112635 may be referred to.

### Wavelength Conversion Member

The wavelength conversion member may be a wavelength conversion body containing a fluorescent material and a light-transmissive material, or may be a wavelength conversion member including a light-transmissive body on which the wavelength conversion body is disposed. The wavelength conversion body preferably contains a first fluorescent material, a second fluorescent material, and a light-transmissive material. The wavelength conversion body may be formed into a plate shape, a sheet shape, or a layered shape. The wavelength conversion member may include a wavelength conversion body in a shape other than a plate shape, a sheet shape, or a layered shape. The wavelength conversion member includes a wavelength conversion body containing a first fluorescent material, a second fluorescent material, and a light-transmissive material; and the wavelength conversion body preferably has a total amount of the first fluorescent material and the second fluorescent material in a range of 50 parts by mass or more and 500 parts by mass or less relative to 100 parts by mass of the light-transmissive material. When the total amount of the first fluorescent material and the second fluorescent material contained in the wavelength conversion body is in the range of 50 parts by mass or more and 500 parts by mass or less relative to 100 parts by mass of the light-transmissive material, the total amount of the first fluorescent material and the second fluorescent material is relatively small relative to the amount of the light-transmissive material, and the heat generated when the fluorescent materials absorb excitation light and emit light can be reduced, so that deterioration of the light emitting device due to heat can be suppressed, and the durability of the light emitting device can be improved. The total amount of the first fluorescent material and the second fluorescent material contained in the wavelength conversion body may be in a range of 80 parts by mass or more and 400 parts by mass or less, may be in a range of 90 parts by mass or more and 350 parts by mass or less, may be in a range of 100 parts by mass or more and 300 parts by mass or less, or may be in a range of 100 parts by mass or more and 270 parts by mass or less, relative to 100 parts by mass of the light-transmissive material. The total amount of the first fluorescent material and the second fluorescent material is also referred to as the total amount of the fluorescent materials.

The wavelength conversion member includes a wavelength conversion body containing a first fluorescent material, a second fluorescent material, and a light-transmissive material; and the wavelength conversion body preferably includes a high-concentration layer having a high filling ratio of the first fluorescent material and the second fluorescent material and having high concentrations of the first fluorescent material and the second fluorescent material, and a low-concentration layer having a low filling ratio of the first fluorescent material and the second fluorescent material and having low concentrations of the first fluorescent material and the second fluorescent material, in the cross-sectional thickness direction. With the wavelength conversion body including a high-concentration layer having a high filling ratio of the first fluorescent material and the second fluorescent material, the wavelength conversion body is less likely to break or crack even when the total amount of the fluorescent materials is small relative to the amount of the light-transmissive material. The high-concentration layer in the wavelength conversion body is preferably disposed on the light emitting element side. By disposing the high-concentration layer on the light emitting element side, the wavelength conversion body can dissipate the heat generated by the light emitting element through the first fluorescent material and the second fluorescent material in the wavelength conversion body. The filling ratio of the fluorescent materials can be measured from the area ratio of the resin to the fluorescent materials in the cross section of the wavelength conversion body or the wavelength conversion member observed using a scanning electron microscope (SEM). The high-concentration layer having a high filling ratio of the fluorescent materials refers to a layer in which the area of the fluorescent materials is larger than that of the resin in the cross section of the wavelength conversion body or the wavelength conversion member. The low-concentration layer having a low filling ratio of the fluorescent materials refers to a layer in which the area of the fluorescent materials is smaller than that of the resin in the cross section of the wavelength conversion body or the wavelength conversion member. The low-concentration layer may be a layer in which the fluorescent materials are substantially absent, no fluorescent material area is observed, and only the resin area can be confirmed. As for the ratio of the thickness of the high-concentration layer and the thickness of the low-concentration layer in the cross section of the wavelength conversion body observed using an SEM, the thickness of the low-concentration layer may be 40% or less, may be 35% or less, or may be 34% or less; and may be 3% or more, or may be 5% or more, relative to a total thickness of the wavelength conversion body being 100%. A large ratio of the thickness of the low-concentration layer indicates a small ratio of the thickness of the high-concentration layer, a high filling ratio of the first fluorescent material and the second fluorescent material contained in the high-concentration layer, and a high density of the high-concentration layer. In order to suppress breakage or cracking of the wavelength conversion body and to increase heat dissipation, it is preferred that the filling ratio of the first fluorescent material and the second fluorescent material contained in the high-concentration layer is high and that the density of the first fluorescent material and the second fluorescent material is high.

FIG. 3C is a partially enlarged view P1 of the schematic cross section of the light emitting device shown in FIG. 3B. For the purpose of explanation, FIG. 3C may differ in scale from FIG. 3B.

The wavelength conversion body 41 includes a high-concentration layer 41a having a high filling ratio of the first fluorescent material 71 and the second fluorescent material 72, and a low-concentration layer 41b having a low filling ratio of the first fluorescent material 71 and the second fluorescent material 72, wherein the high-concentration layer 41a is disposed on the light emitting element 10 side. The low-concentration layer 41b in the wavelength conversion body 41 is disposed on the light-transmissive body 42 side. The wavelength conversion body 41 is provided on the light emitting surface of the light emitting element 10 via the adhesive layer 80.

As high-output light emitting devices are increasingly being used in headlights, there are cases in which wavelength conversion members having a resin composition containing a fluorescent material coated on a light-transmissive body formed of glass having high heat resistance, or wavelength conversion members having high heat resistance, such as sintered bodies containing a fluorescent material and a light-transmissive material, are used. For the fluorescent material contained in the wavelength conversion member having high heat resistance, a fluorescent material considered to have relatively high heat resistance compared to other fluorescent materials, such as a rare earth aluminate fluorescent material having a composition represented by Y₃Al₅O₁₂:Ce, may also be used. Because the rare earth aluminate fluorescent material has a relatively low light emission intensity on the long-wavelength side, such as 570 nm or more, it is considered to generally emit light having a correlated color temperature of around 6,000 K when used in headlights. Therefore, when the fluorescent material contained in the wavelength conversion member is formed only of, for example, a rare earth aluminate fluorescent material having a composition represented by Y₃Al₅O₁₂:Ce, it is considered difficult to achieve a headlight capable of emitting light having a correlated color temperature of 5,000 K or less. The light emitting device according to the first embodiment or the second embodiment may contain, as a fluorescent material contained in a sintered body used in the wavelength conversion member, one type of the aforementioned first and second fluorescent materials alone, or may contain two or more types of the aforementioned first and second fluorescent materials. The fluorescent material contained in the sintered body includes, as the first fluorescent material, a fluorescent material having a composition represented by the formula (1A), and may include, for example, the following fluorescent materials.

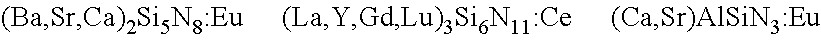

For the sintered body used in the wavelength conversion member, a single sintered body containing a fluorescent material having a composition represented by the formula (1A) and a second nitride fluorescent material may be used, or a sintered body in which a sintered body containing a fluorescent material having a composition represented by the formula (1A) and a sintered body containing a second nitride fluorescent material are combined in two layers, may be used.

The wavelength conversion body used in the wavelength conversion member may be, when glass is used as the light-transmissive material, a wavelength conversion body containing, for example, glass and an α-SiAlON fluorescent material having a composition formula represented by M⁸ᵥ₃(Si,Al)₁₂(O,N)₁₆:Eu (wherein M⁸ represents Li, Mg, Ca, Y, and lanthanide elements excluding La and Ce, and v3 satisfies 0<v3≤2).

Even by using the above as the wavelength conversion member, the light emitting device can emit light having a correlated color temperature of 5,000 K or less, and by using the light emitting device, it is considered to provide a headlight capable of reducing glare and a vehicle equipped with the same.

### Light-Transmissive Material

Examples of the light-transmissive material include at least one selected from the group consisting of a resin, glass, and an inorganic substance. The resin is preferably at least one selected from the group consisting of an epoxy resin, a silicone resin, a phenol resin, and a polyimide resin. Examples of the inorganic substance include at least one selected from the group consisting of aluminum oxide and aluminum nitride.

When the light-transmissive material is a resin, the resin preferably has a Shore A hardness in a range of 30 or more and 80 or less. The light-transmissive material is preferably a silicone resin, more preferably a silicone resin having a Shore A hardness in a range of 30 or more and 80 or less. The Shore A hardness of the silicone resin, which is the light-transmissive material, is more preferably in a range of 40 or more and 75 or less, even more preferably in a range of 50 or more and 70 or less. When the light-transmissive material is a resin, the resin expands or contracts when exposed to light or heat. When the light-transmissive material is a silicone resin having a Shore A hardness of 30 or more and 80 or less, it has excellent toughness and elongation. Therefore, even when the environmental ambient temperature changes, the light-transmissive material flexibly expands and contracts according to the temperature change, and the wavelength conversion body is less likely to break or crack and emits light with a first luminance ratio Ls/L maintained at 0.9 or less, thereby providing good temperature characteristics. When the light-transmissive material is a silicone resin having a Shore A hardness of 30 or more and 80 or less, the light-transmissive material flexibly expands and contracts according to the temperature change, and the wavelength conversion body is less likely to break or crack and emits light with a second luminance ratio B/A maintained at 0.104 or less, thereby providing good temperature characteristics. The Shore A hardness of resins can be measured using a Durometer Type A in accordance with JIS K6253.

For example, when a wavelength conversion body is formed by using a resin having a low Shore A hardness of less than 30 as a light-transmissive material, the wavelength conversion body becomes soft and sticky. Therefore, it may be difficult to cut the wavelength conversion body when individual light emitting devices are separated from a substrate block including a plurality of light emitting elements, and it may also be difficult to transport and package the wavelength conversion body, resulting in poor mass production.

Thus, by using a resin having a Shore A hardness of 30 or more and 80 or less as a light-transmissive material, the wavelength conversion body or the wavelength conversion member is less likely to break or crack, thereby obtaining a wavelength conversion body having good temperature characteristics.

### Light-Transmissive Body

The wavelength conversion member may include a light-transmissive body. The light-transmissive body can use a plate-shaped body formed of a light-transmissive material such as glass or resin. Examples of the glass include borosilicate glass and quartz glass. Examples of the resin include a silicone resin and an epoxy resin. The thickness of the light-transmissive body may be any thickness as long as the mechanical strength is not reduced in the producing process and the wavelength conversion body can be adequately supported.

### Substrate

The substrate is preferably formed of an insulating material that is difficult to transmit light from the light emitting element or external light. Examples of the material of the substrate include ceramics such as aluminum oxide and aluminum nitride, and resins such as a phenol resin, an epoxy resin, a polyimide resin, a bismaleimide triazine resin (BT resin), and a polyphthalamide (PPA) resin. Ceramics have high heat resistance and are therefore preferred as a substrate material.

### Adhesive Layer

The adhesive layer is interposed between the light emitting element and the wavelength conversion member to fix the light emitting element and the wavelength conversion member together. An adhesive constituting the adhesive layer is preferably formed of a material capable of optically bonding the light emitting element and the wavelength conversion member. The material constituting the adhesive layer is preferably at least one resin selected from the group consisting of an epoxy resin, a silicone resin, a phenol resin, and a polyimide resin.

### Semiconductor Element

Examples of the semiconductor element optionally provided in the light emitting device include a transistor for controlling the light emitting element and a protective element for suppressing destruction or performance deterioration of the light emitting element due to excessive voltage application. Examples of the protective element include a Zener diode.

### Covering Member

An insulating material is preferably used as the material of the covering member. More specific examples thereof include a phenol resin, an epoxy resin, a bismaleimide triazine resin (BT resin), a polyphthalamide (PPA) resin, and a silicone resin. A colorant, a fluorescent material, and a filler may be optionally added to the covering member.

### Conductive Members

Bumps can be used as the conductive members. Examples of the material of the bumps include Au and an alloy thereof, and examples of the other conductive members include eutectic solder (Au—Sn), Pb—Sn, and lead-free solder.

### Method for Producing Light Emitting Device

The following describes an example of the method for producing a light emitting device. For the details, for example, the disclosure of Japanese Unexamined Patent Publication No. 2014-112635 or Japanese Unexamined Patent Publication No. 2017-117912 may be referred to. The method for producing a light emitting device preferably includes a step of disposing a light emitting element, a discretionary step of disposing a semiconductor element, a step of forming a wavelength conversion member including a wavelength conversion body, a step of adhering a light emitting element and a wavelength conversion member, and a step of forming a covering member.

### Step of Disposing Light Emitting Element

A light emitting element is disposed on a substrate. For example, a light emitting element and a semiconductor element are flip-chip mounted on a substrate.

### Step of Forming Wavelength Conversion Member Including Wavelength Conversion Body

In the step of forming a wavelength conversion member including a wavelength conversion body, a wavelength conversion body may be obtained by forming a plate-shaped, sheet-shaped, or layered wavelength conversion body on one surface of a light-transmissive body by a printing method, an adhesive method, a compression molding method, or an electrodeposition method. For example, in the printing method, a wavelength conversion body composition containing a fluorescent material and a resin serving as a light-transmissive material can be printed on one surface of a light-transmissive body to form a wavelength conversion member including a wavelength conversion body.

### Wavelength Conversion Body Composition

The wavelength conversion body composition constituting the wavelength conversion body or the wavelength conversion member contains a light-transmissive material, a first fluorescent material, and a second fluorescent material, and may contain a solvent. When the wavelength conversion body composition contains a solvent, the viscosity of the wavelength conversion body composition is lowered, and the density of the first and second fluorescent materials increases in the direction of gravity during curing of the wavelength conversion body composition, even when the total amount of the fluorescent materials is small relative to the amount of the light-transmissive material, thereby producing a wavelength conversion body or wavelength conversion member having different filling ratios of the first and second fluorescent materials in the wavelength conversion body or wavelength conversion member. The wavelength conversion body or wavelength conversion member is less likely to break or crack due to the presence of a portion having a high filling ratio of the first fluorescent material and the second fluorescent material. By disposing the high-concentration layer side, which has a high filling ratio of the first fluorescent material and the second fluorescent material in the wavelength conversion body, on the light emitting element side, even when a high-output light emitting element is used, the wavelength conversion body can dissipate the heat generated by the light emitting element through the first fluorescent material and the second fluorescent material in the wavelength conversion body, can suppress breakage or cracking of the resin constituting the wavelength conversion body, and can emit light with a first luminance ratio Ls/L maintained at 0.9 or less, thereby providing good temperature characteristics. Also, by disposing the high-concentration layer side, which has a high filling ratio of the first fluorescent material and the second fluorescent material in the wavelength conversion body, on the light emitting element side, even when a high-output light emitting element is used, the wavelength conversion body can dissipate the heat generated by the light emitting element through the first fluorescent material and the second fluorescent material in the wavelength conversion body, can suppress breakage or cracking of the resin constituting the wavelength conversion body, and can emit light with a second luminance ratio B/A maintained at 0.104 or less, thereby providing good temperature characteristics.

The solvent preferably has a boiling point in a range of 150° C. or higher and 320° C. or lower under standard pressure (0.101 MPa), more preferably in a range of 170° C. or higher and 305° C. or lower, even more preferably in a range of 180° C. or higher and 300° C. or lower, and particularly preferably in a range of 190° C. or higher and 290° C. or lower, in view of solubility and volatility in the light-transmissive resin. When the wavelength conversion body composition contains a solvent having a boiling point in a range of 150° C. or higher and 320° C. or lower under standard pressure, the viscosity of the wavelength conversion body composition can be reduced to form a high-concentration layer having a high filling ratio of fluorescent materials including the first fluorescent material and the second fluorescent material, and a low-concentration layer having a low filling ratio of the first fluorescent material and the second fluorescent material in the direction of gravity during curing.

The wavelength conversion body composition preferably has a viscosity, as measured using an E-type viscometer, in a range of 5 mPa·s or more and 400 mPa·s or less, more preferably in a range of 6 mPa·s or more and 300 mPa·s or less, and even more preferably in a range of 8 mPa·s or more and 250 mPa·s or less, at 25° C. and 1 rpm.

When the light-transmissive material is a silicone resin and the wavelength conversion body composition contains fluorescent materials in a total amount in a range of 50 parts by mass or more and 500 parts by mass or less relative to 100 parts by mass of the light-transmissive material, the content of the solvent is preferably in a range of 1 part by mass or more and 50 parts by mass or less, more preferably in a range of 2 parts by mass or more and 40 parts by mass or less, and even more preferably in a range of 3 parts by mass or more and 30 parts by mass or less, relative to 100 parts by mass of the light-transmissive material.

The solvent is a liquid organic compound, some of which evaporates (volatilizes) at room temperature. By heating at, for example, 180° C. or higher, the solvent remaining in the wavelength conversion body composition can be volatilized to cure the wavelength conversion body composition, thereby forming a wavelength conversion body or a wavelength conversion member. Examples of the solvent include hydrocarbon solvents, ketone solvents, alcohol solvents, aldehyde solvents, glycol solvents, ether solvents, ester solvents, glycol ether solvents, and glycol ester solvents. Examples of the hydrocarbon solvents include hexane, xylene, heptane, decane, dodecane, and tridecane. Examples of the ketone solvents include acetone and methyl ethyl ketone. Examples of the alcohol solvents include methyl alcohol, ethyl alcohol, and isopropyl alcohol. Examples of the aldehyde solvents include nonanal and decanal. Examples of the glycol solvents include triethylene glycol. Examples of the ether solvents include diethyl ether. Examples of the ester solvents include methyl acetate and ethyl acetate. Examples of the glycol ether solvents include propylene glycol monomethyl ether. Examples of the glycol ester solvents include ethylene glycol monoethyl ether acetate. The solvent is preferably at least one selected from the group consisting of hexane, xylene, heptane, acetone, ethanol, isopropyl alcohol, decane, dodecane, tridecane, tetradecane, pentadecane, hexadecane, nonanal, decanal, and triethylene glycol. More preferably, the solvent is at least one selected from the group consisting of dodecane, tetradecane, pentadecane, hexadecane, and tridecane. One solvent may be used alone, and two or more solvents may be used in combination.

### Wavelength Conversion Body and Wavelength Conversion Member

When the wavelength conversion body composition contains a solvent, it is possible to form a wavelength conversion body or wavelength conversion member divided into a high-concentration layer having a high filling ratio of the first fluorescent material and the second fluorescent material, and a low-concentration layer having a low filling ratio of the first fluorescent material and the second fluorescent material in the direction of gravity during curing of the wavelength conversion body composition. In the present specification, a high-concentration layer having a high filling ratio of the fluorescent materials and a low-concentration layer having a low filling ratio of the fluorescent materials can be observed in the thickness direction of the cross section of the wavelength conversion body. The filling ratio of the fluorescent materials can be measured, as described above, from the area ratio of the resin to the fluorescent materials in the cross section of the wavelength conversion body or the wavelength conversion member observed using an SEM. The boundary between one layer and another layer may not be a straight line, but may be an uneven line.

### Step of Adhering Light Emitting Element and Wavelength Conversion Member

In the step of adhering a light emitting element and a wavelength conversion member, the wavelength conversion member is allowed to face to the light emitting surface of the light emitting element, and the wavelength conversion member is adhered onto the light emitting element by the adhesive layer. When the wavelength conversion member includes a wavelength conversion body and a light-transmissive body, and the wavelength conversion body includes a high-concentration layer having a high filling ratio of fluorescent materials and a low-concentration layer having a low filling ratio of fluorescent materials, it is preferred that the high-concentration layer having a high filling ratio in the wavelength conversion body is disposed on the light emitting element side, and the wavelength conversion member is adhered on the light emitting element. The fluorescent materials including the first fluorescent material and the second fluorescent material have higher thermal conductivity than that of resins. Therefore, by disposing the high-concentration layer having a high filling ratio of the fluorescent materials in the wavelength conversion body on the light emitting element side to adhere the wavelength conversion member, the heat dissipation is improved, and the wavelength conversion body is less likely to break or crack, resulting in good temperature characteristics.

### Step of Forming Covering Member

In the step of forming a covering member, the lateral surfaces of the light emitting element and the wavelength conversion member are covered with a covering member composition. The covering member is for reflecting light emitted by the light emitting element, and when the light emitting device also includes a semiconductor element, the semiconductor element is preferably formed to be embedded in the covering member. The production method may include a step of separating individual light emitting devices from a substrate block including a plurality of light emitting elements and semiconductor elements on one substrate.

For example, when a wavelength conversion body is formed by using a resin having a low Shore A hardness of less than 30 as a light-transmissive material, the wavelength conversion body becomes soft and sticky. Therefore, it may be difficult to cut the wavelength conversion body when individual light emitting devices are separated from a substrate block including a plurality of light emitting elements, and it may also be difficult to transport and package the wavelength conversion body, resulting in poor mass production.

Thus, by using a resin having a Shore A hardness of 30 or more and 80 or less as a light-transmissive material, the wavelength conversion body or the wavelength conversion member is less likely to break or crack, thereby obtaining a wavelength conversion body having good temperature characteristics.

### Headlight

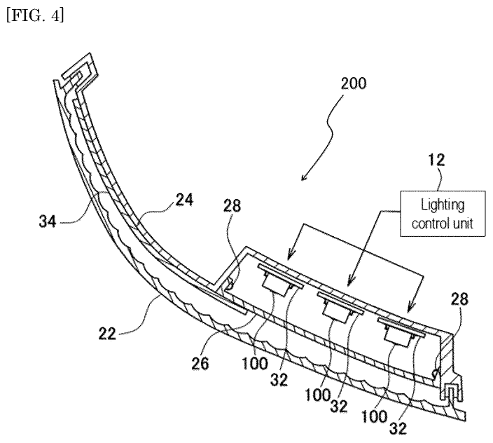

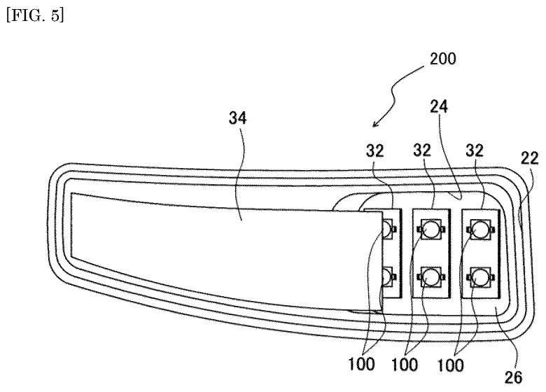

The light emitting device may be disposed on a supporting substrate of a light source unit for a headlight and used as a headlight mounted on a vehicle. The light source unit for a headlight may be, for example, a light source unit disclosed in Japanese Unexamined Patent Publication No. 2003-317513. The light source unit includes, for example, a reflector, a projection lens, and a supporting substrate on which the light emitting device is disposed. The light emission of the light source unit for a headlight may be controlled by a vehicle lamp system as disclosed in, for example, Japanese Unexamined Patent Publication No. H08-67199. The light emitting device may be used as a light source for a headlight used in a turn signal lamp as disclosed in, for example, Japanese Unexamined Patent Publication No. 2005-123165. FIG. 4 shows a horizontal cross-sectional view of a headlight 200. FIG. 5 shows a front view of the headlight 200. For example, the headlight 200 shown in FIGS. 4 and 5 is mounted on the right front side of the vehicle. The headlight 200 includes a lamp body 24, an outer lens 22, a plurality of substrates 32, a plurality of light emitting devices 100, an optical filter 26, and a light guide member 34. The lamp body 24 and the outer lens 22 form a lamp chamber of the headlight 200, and the plurality of substrates 32 and the plurality of light emitting devices 100 are held in the lamp chamber while being waterproof. The lamp body 24 is formed of, for example, resin so as to cover the plurality of substrates 32 and the plurality of light emitting devices 100 from the rear of the vehicle. The optical filter 26 is fixed to the lamp body 24 by a plurality of screws 28. The plurality of light emitting devices 100 each emit light according to power received from a lighting control unit 12 via the substrates 32.

The headlight may include a plurality of first lamp units each having one light emitting device disposed in one light source unit, as disclosed in, for example, Japanese Unexamined Patent Publication No. 2003-317513. The headlight may also include a second lamp unit in which a plurality of light emitting devices are disposed in one light source unit integrally formed with a plurality of reflectors, a plurality of projection lenses, and a plurality of supporting substrates, as disclosed in, for example, Japanese Unexamined Patent Publication No. 2005-141917. The headlight may include two or more types of light emitting devices having different first luminance ratios Ls/L. The two or more types of light emitting devices having different first luminance ratios Ls/L may each have one light emitting device disposed in one light source unit. The two or more types of light emitting devices having different first luminance ratios Ls/L may be disposed in one light source unit. The headlight may include two or more types of light emitting devices having different second luminance ratios B/A. The two or more types of light emitting devices having different second luminance ratios B/A may each have one light emitting device disposed in one light source unit. The two or more types of light emitting devices having different second luminance ratios B/A may be disposed in one light source unit.

The headlight may include two or more types of light emitting devices, including the aforementioned light emitting device that emits light having a first luminance ratio Ls/L of 0.9 or less as a first light emitting device and the light emitting device that emits light having a first luminance ratio Ls/L of more than 0.9 as a second light emitting device.

The headlight may include two or more types of light emitting devices, including the aforementioned light emitting device that emits light having a second luminance ratio B/A of 0.104 or less as a first light emitting device and the light emitting device that emits light having a second luminance ratio B/A of more than 0.104 as a second light emitting device.

The second light emitting device may be a light emitting device that emits light having a first luminance ratio Ls/L of more than 0.9, or a light emitting device that emits light having a second luminance ratio B/A of more than 0.104. The second light emitting device may be in the same or similar form as the first light emitting device shown in, for example, FIGS. 3A and 3B. Examples of the second light emitting device include a light emitting device including a light emitting element having a light emission peak wavelength in a range of 400 nm or more and 490 nm or less and a first fluorescent material having a light emission peak wavelength in a range of 480 nm or more and less than 580 nm, and not including a second fluorescent material. Examples of the first fluorescent material include the same or similar fluorescent material as the first fluorescent material described above. The second light emitting device includes a light emitting device including a light emitting element having a light emission peak wavelength in a range of 400 nm or more and 490 nm or less and a rare earth aluminate fluorescent material having a composition represented by the formula (1A) as a first fluorescent material, and not including a second fluorescent material, which emits light having a first luminance ratio Ls/L of more than 0.9 or a second luminance ratio B/A of more than 0.104, and a correlated color temperature in a range of 5,000 K or more and 6,500 K or less.

### Vehicle

The vehicle according to the third embodiment comprises a vehicle including the aforementioned light emitting device or headlight. Examples of the vehicle including the aforementioned light emitting device or headlight include road transportation vehicles such as motorcycles and automobiles, railway vehicles, and vehicles used for tractor-type construction machines such as ground leveling, transporting, and loading machines, or excavator-type construction machines such as excavating machines.

Embodiments according to the present disclosure include the following light emitting device, headlight, and vehicle.
[Aspect 1] A light emitting device, comprising:
   a light emitting element having a light emission peak wavelength in a range of 400 nm or more and 490 nm or less; and
   a wavelength conversion member including,
      a first fluorescent material having a light emission peak wavelength in a range of 480 nm or more and less than 580 nm, and
      a second fluorescent material having a light emission peak wavelength in a range of 580 nm or more and 680 nm or less, and having a composition different from a composition of the first fluorescent material,
   the light emitting device emitting light having a first luminance ratio Ls/L, as derived from the following formula (1), of 0.9 or less,
   the first luminance ratio Ls/L being a ratio of a first effective radiance Ls of the light emitted by the light emitting device in a range of 380 nm or more and 780 nm or less in consideration of a spectral luminous efficiency curve for photopic vision of humans specified by CIE (Commission Internationale de l'Eclairage) and an S-cone spectral sensitivity of humans, to a luminance L of the light emitted by the light emitting device in a range of 380 nm or more and 780 nm or less in consideration of the spectral luminous efficiency curve for photopic vision of humans,
   the first fluorescent material comprising a rare earth aluminate fluorescent material having a composition represented by the following formula (1A):

$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$

wherein S (λ) represents a spectral radiance of the light emitted by the light emitting device, V (λ) represents a spectral luminous efficiency curve for photopic vision of humans specified by CIE (Commission Internationale de l'Eclairage), and Gs (λ) represents the S-cone spectral sensitivity of humans in a wavelength A range of 380 nm or more and 550 nm or less; and

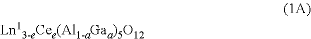

wherein Ln¹ represents at least one element selected from the group consisting of Y, Gd, Tb, and Lu, and a and e satisfy 0≤a≤0.5 and 0.019≤e≤0.2.
[Aspect 2] The light emitting device according to claim 1, wherein the light emitting device emits light having a correlated color temperature of 1,800 K or more and 5,000 K or less.
[Aspect 3] The light emitting device according to claim 1 or 2, wherein the first fluorescent material has a light emission spectrum having a full width at half maximum in a range of 90 nm or more and 125 nm or less.
[Aspect 4] The light emitting device according to any one of claims 1 to 3, wherein the second fluorescent material has a light emission spectrum having a full width at half maximum in a range of 3 nm or more and 15 nm or less, or a light emission spectrum having a full width at half maximum in a range of 60 nm or more and 120 nm or less.
[Aspect 5] The light emitting device according to any one of claims 1 to 4, wherein the rare earth aluminate fluorescent material having a composition represented by the formula (1A) has an average particle diameter, as measured according to a Fisher Sub-Sieve Sizer method, in a range of 15 μm or more and 40 μm or less.
[Aspect 6] The light emitting device according to any one of claims 1 to 5, wherein the first fluorescent material comprises a rare earth aluminate fluorescent material having a composition represented by the formula (1A), and further comprises a first nitride fluorescent material having a composition represented by the following formula (1B):

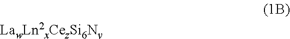

wherein Ln² necessary includes at least one selected from the group consisting of Y and Gd, and may include at least one selected from the group consisting of Sc and Lu, the total of Y and Gd included in Ln² is 90 mol % or more relative to the Ln² elements included in 1 mol of the composition being 100 mol %, and w, x, y, and z satisfy 1.2≤w≤2.2, 0.5≤x≤1.2, 10≤y≤12, 0.5≤z≤1.2, 1.80<w+x<2.40, and 2.9<w+x+z≤3.1.
[Aspect 7] The light emitting device according to any one of claims 1 to 6, wherein the second fluorescent material comprises at least one selected from the group consisting of a second nitride fluorescent material having a composition represented by the following formula (2A), a third nitride fluorescent material having a composition represented by the following formula (2B), a fluoride fluorescent material having a composition represented by the following formula (2C), a fluoride fluorescent material having a composition represented by the following formula (2C′) that is different in composition from the following formula (2C), and an α-SiAlON fluorescent material having a composition represented by the following formula (2G):

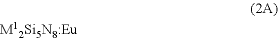

wherein M¹ represents an alkaline earth metal element containing at least one selected from the group consisting of Ca, Sr, and Ba;

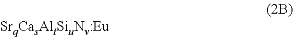

wherein q, s, t, u, and v satisfy 0≤q<1, 0<s≤1, q+s≤1, 0.9≤t≤1.1, 0.9≤u≤1.1, and 2.5≤v≤3.5;

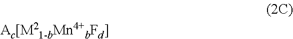

wherein A includes at least one selected from the group consisting of K⁺, Li⁺, Nat, Rb⁺, Cs⁺, and NH₄⁺, M² includes at least one element selected from the group consisting of Group 4 elements and Group 14 elements, b satisfies 0<b<0.2, c represents an absolute value of the charge of [M²_{1-b}Mn⁴⁺_{b}F_{d}] ions, and d satisfies 5<d<7;

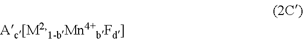

wherein A′ includes at least one selected from the group consisting of K⁺, Li⁺, Nat, Rb⁺, Cs⁺, and NH₄⁺, M^{2′} includes at least one element selected from the group consisting of Group 4 elements, Group 13 elements, and Group 14 elements, b′ satisfies 0<b′<0.2, c′ represents an absolute value of the charge of [M^{2′}_{1-b′}Mn⁴⁺_{b′}F_{d′}] ions, and d′ satisfies 5<d′<7; and

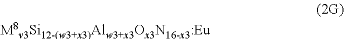

wherein M⁸ includes at least one element selected from the group consisting of Li, Mg, Ca, Sr, Y, and lanthanoid elements (excluding La and Ce), and v3, w3, and x3 satisfy 0<v3≤2.0, 2.0≤w3≤6.0, and 0≤x3≤1.0.
[Aspect 8] The light emitting device according to any one of claims 1 to 7, wherein
   the wavelength conversion member comprises a wavelength conversion body including the first fluorescent material, the second fluorescent material, and a light-transmissive material, and
   a total amount of the first fluorescent material and the second fluorescent material is in a range of 50 parts by mass or more and 500 parts by mass or less relative to an amount of the light-transmissive material in the wavelength conversion body being 100 parts by mass.
[Aspect 9] The light emitting device according to any one of claims 1 to 8,
   wherein the wavelength conversion member comprises a wavelength conversion body including the first fluorescent material, the second fluorescent material, and a light-transmissive material,
   the wavelength conversion body comprises,
      a high-concentration layer having a high filling ratio of the first fluorescent material and the second fluorescent material, and
      a low-concentration layer having a low filling ratio of the first fluorescent material and the second fluorescent material, and
   the high-concentration layer is disposed on the light emitting element side.
[Aspect 10] A headlight, comprising the light emitting device according to any one of claims 1 to 9.
[Aspect 11] The headlight according to claim 10, comprising two or more types of light emitting devices each having a different value of the first luminance ratio Ls/L.
[Aspect 12] A headlight, comprising two or more types of light emitting devices including a first light emitting device including the light emitting device according to any one of claims 1 to 9, and a second light emitting device that emits light having a first luminance ratio Ls/L, as derived from the following formula (1), of more than 0.9, the first luminance ratio Ls/L being a ratio of a first effective radiance of the light emitted by the light emitting device in a range of 380 nm or more and 780 nm or less in consideration of a spectral luminous efficiency curve for photopic vision of humans specified by CIE (Commission Internationale de l'Eclairage) and the S-cone spectral sensitivity of humans, to a luminance L of the light emitted by the light emitting device in a range of 380 nm or more and 780 nm or less in consideration of the spectral luminous efficiency curve for photopic vision of humans:

$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$

wherein S (λ) represents a spectral radiance of the light emitted by the light emitting device, V (λ) represents a spectral luminous efficiency curve for photopic vision of humans specified by CIE (Commission Internationale de l'Eclairage), and Gs (λ) represents the S-cone spectral sensitivity of humans in a wavelength A range of 380 nm or more and 550 nm or less.
[Aspect 13] A light emitting device, comprising:
   a light emitting element having a light emission peak wavelength in a range of 400 nm or more and 490 nm or less; and
   a wavelength conversion member including,
      a first fluorescent material having a light emission peak wavelength in a range of 480 nm or more and less than 580 nm, and
      a second fluorescent material having a light emission peak wavelength in a range of 580 nm or more and 680 nm or less and having a composition different from a composition of the first fluorescent material,
   the light emitting device emitting light having a second luminance ratio B/A, as derived from the following formula (2), of 0.104 or less,
   the second luminance ratio B/A being a ratio of a second effective radiance B of the light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less, the first fluorescent material comprising a rare earth aluminate fluorescent material having a composition represented by the following formula (1A):

$$B / A = \frac{{\int }_{300}^{800} Dc ( λ ) \times S ( λ ) d λ}{{\int }_{300}^{800} S ( λ ) d λ} \qquad ( 2 )$$

wherein S (λ) represents a spectral radiance of the light emitted by the light emitting device, and Dc (λ) denotes a scattering intensity curve, normalized to 1 at a wavelength of 300 nm for Rayleigh scattering; and

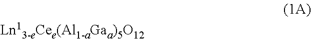

wherein Ln¹ represents at least one element selected from the group consisting of Y, Gd, Tb, and Lu, and a and e satisfy 0≤a≤0.5 and 0.019≤e≤0.2.
[Aspect 14] The light emitting device according to claim 13, wherein the emitting device emits light having a correlated color temperature of 1,800 K or more and 5,000 K or less.
[Aspect 15] The light emitting device according to claim 13 or 14, wherein the first fluorescent material has a light emission spectrum having a full width at half maximum in a range of 90 nm or more and 125 nm or less. [Aspect 16] The light emitting device according to any one of claims 13 to 15, wherein the second fluorescent material has a light emission spectrum having a full width at half maximum in a range of 3 nm or more and 15 nm or less, or a light emission spectrum having a full width at half maximum in a range of 60 nm or more and 120 nm or less.
[Aspect 17] The light emitting device according to any one of claims 13 to 16, wherein the first fluorescent material comprises a rare earth aluminate fluorescent material having a composition represented by the formula (1A), and further comprises a first nitride fluorescent material having a composition represented by the following formula (1B):

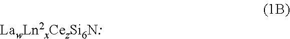

wherein Ln² necessary includes at least one selected from the group consisting of Y and Gd, and may include at least one selected from the group consisting of Sc and Lu, the total of Y and Gd included in Ln² is 90 mol % or more relative to the Ln² elements included in 1 mol of the composition being 100 mol %, and w, x, y, and z satisfy 1.2≤w≤2.2, 0.5≤x≤1.2, 10≤y≤12, 0.5≤z≤1.2, 1.80<w+x<2.40, and 2.9≤w+x+z≤3.1.
[Aspect 18] The light emitting device according to any one of claims 13 to 17, wherein the second fluorescent material comprises at least one selected from the group consisting of a second nitride fluorescent material having a composition represented by the following formula (2A), a third nitride fluorescent material having a composition represented by the following formula (2B), a fluoride fluorescent material having a composition represented by the following formula (2C), a fluoride fluorescent material having a composition represented by the following formula (2C′) that is different in composition from the following formula (2C), and an α-SiAlON fluorescent material having a composition represented by the following formula (2G):

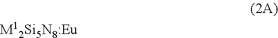

wherein M¹ represents an alkaline earth metal element containing at least one selected from the group consisting of Ca, Sr, and Ba;

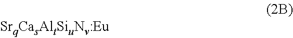

wherein q, s, t, u, and v satisfy 0≤q<1, 0<s≤1, q+s≤1, 0.9≤t≤1.1, 0.9≤u≤1.1, and 2.5≤v≤3.5;

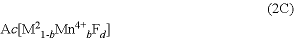

wherein A includes at least one selected from the group consisting of K⁺, Li⁺, Nat, Rb⁺, Cs⁺, and NH₄⁺, M^{2′} includes at least one element selected from the group consisting of Group 4 elements and Group 14 elements, b satisfies 0<b<0.2, c represents an absolute value of the charge of [M²_{1-b}Mn⁴⁺_{b}F_{d}] ions, and d satisfies 5<d<7;

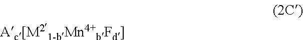

wherein A′ includes at least one selected from the group consisting of K⁺, Li⁺, Nat, Rb⁺, Cs⁺, and NH₄⁺, M^{2′} includes at least one element selected from the group consisting of Group 4 elements, Group 13 elements, and Group 14 elements, b′ satisfies 0<b′<0.2, c′ represents an absolute value of the charge of [M^{2′}_{1-b′}Mn⁴⁺_{b′}F_{d′}] ions, and d′ satisfies 5<d′<7; and

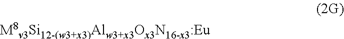

wherein M⁸ includes at least one element selected from the group consisting of Li, Mg, Ca, Sr, Y, and lanthanoid elements (excluding La and Ce), and v3, w3, and x3 satisfy 0<v3≤2.0, 2.0≤w3≤6.0, and 0≤x3≤1.0.
[Aspect 19] The light emitting device according to any one of claims 13 to 18, wherein the rare earth aluminate fluorescent material having a composition represented by the formula (1A) has an average particle diameter, as measured according to a Fisher Sub-Sieve Sizer method, in a range of 15 μm or more and 40 μm or less.
[Aspect 20] The light emitting device according to any one of claims 13 to 19, wherein
   the wavelength conversion member comprises a wavelength conversion body including the first fluorescent material, the second fluorescent material, and a light-transmissive material, and
   a total amount of the first fluorescent material and the second fluorescent material is in a range of 50 parts by mass or more and 500 parts by mass or less relative to an amount of the light-transmissive material in the wavelength conversion body being 100 parts by mass.
[Aspect 21] The light emitting device according to any one of claims 13 to 20,
   wherein the wavelength conversion member comprises a wavelength conversion body including the first fluorescent material, the second fluorescent material, and a light-transmissive material,
   the wavelength conversion body comprises,
      a high-concentration layer having a high filling ratio of the first fluorescent material and the second fluorescent material, and
      a low-concentration layer having a low filling ratio of the first fluorescent material and the second fluorescent material, and
   the high-concentration layer is disposed on the light emitting element side.
[Aspect 22] A headlight, comprising the light emitting device according to any one of claims 13 to 21.
[Aspect 23] The headlight according to claim 22, comprising two or more types of light emitting devices each having a different value of the second luminance ratio B/A.
[Aspect 24] A headlight, comprising two or more types of light emitting devices including
   a first light emitting device including the light emitting device according to any one of claims 13 to 21, and
   a second light emitting device that emits light having a second luminance ratio B/A, as derived from the following formula (2), of more than 0.104, the second luminance ratio B/A being a ratio of a second effective radiance B of the light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less:

$$B / A = \frac{{\int }_{300}^{800} Dc ( λ ) \times S ( λ ) d λ}{{\int }_{300}^{800} S ( λ ) d λ} \qquad ( 2 )$$

wherein S (λ) represents a spectral radiance of the light emitted by the light emitting device, and Dc (λ) denotes a scattering intensity curve, normalized to 1 at a wavelength of 300 nm for Rayleigh scattering.
[Aspect 25] A vehicle, comprising the light emitting device according to any one of claims 1 to 9 and 13 to 21.
[Aspect 26] A vehicle, comprising the headlight according to any one of claims 10 to 12 and 22 to 24.

### EXAMPLES

The present disclosure is hereunder specifically described by reference to the following Examples. The present disclosure is not limited to the following Examples.

For the light emitting devices according to Examples and Comparative Examples, the following first fluorescent materials and second fluorescent material were used.

### First Fluorescent Material

For the first fluorescent material, rare earth aluminate fluorescent materials YAG-1, YAG-2, YAG-3, YAG-4, and YAG-5 were prepared, each having a composition represented by the formula (1A), wherein Ln¹ in the formula (1A) is Y, and the molar ratio of Ce (parameter e in the formula (1A)) contained in the composition is the value shown in Table 1. YAG-6 was also prepared for the first fluorescent material, having a composition not included in the formula (1A), wherein Ln¹ in the formula (1A) is Y, and the molar ratio of Ce contained in the composition is 0.018. These first fluorescent materials have different average particle diameters measured by the FSSS method, CIE chromaticity coordinates (x, y), light emission peak wavelengths, and full widths at half maximum, as shown in Table 1. In the present specification, the symbol “-” in Table 1 indicates that there is no corresponding item or numerical value.

### Second Fluorescent Material

For the second fluorescent material, BSESN-1, which is a second nitride fluorescent material having a composition represented by the formula (2A), was prepared. The second fluorescent material has an average particle diameter measured by the FSSS method, CIE chromaticity coordinates (x, y), a light emission peak wavelength, and a full width at half maximum, as shown in Table 1.

### Light Emission Spectrum of Fluorescent Material

Each fluorescent material was irradiated with light having an excitation wavelength of 450 nm using a quantum efficiency measuring apparatus (QE-2000, manufactured by Otsuka Electronics Co., Ltd.) to measure the light emission spectrum at room temperature (approximately 25° C.), and the x and y values in the CIE1931 chromaticity coordinates, the light emission peak wavelength, and the full width at half maximum were determined from each light emission spectrum.

### Average Particle Diameter of Fluorescent Material

The average particle diameter of each fluorescent material was measured by the FSSS method using a Fisher Sub-Sieve Sizer Model 95 (manufactured by Fisher Scientific Inc.). Specifically, each fluorescent material was weighed to form a sample having a volume of 1 cm³, the sample was packed in a dedicated tubular container, followed by the flow of dry air at a constant pressure, and the specific surface area was read from the differential pressure and converted to the average particle diameter (Fisher Sub-Sieve Sizer's No.).

TABLE 1

| | Ce | Average | | | Light emission | Full width |
|---|---|---|---|---|---|---|
| | molar ratio | particle | Chromaticity | | peak | at half |
| Fluorescent | formula (1A) | diameter | coordinates | | wavelength | maximum |
| material | parameter e | (μm) | x | y | (nm) | (nm) |
| YAG-1 | 0.025 | 26.5 | 0.429 | 0.550 | 547 | 111.1 |
| YAG-2 | 0.064 | 23.0 | 0.450 | 0.535 | 559 | 111.0 |
| YAG-3 | 0.082 | 18.0 | 0.469 | 0.520 | 564 | 117.0 |
| YAG-4 | 0.095 | 23.5 | 0.471 | 0.518 | 564 | 117.7 |
| YAG-5 | 0.112 | 28.5 | 0.479 | 0.512 | 567 | 117.0 |
| YAG-6 | 0.018 | 27.5 | 0.423 | 0.554 | 545 | 111.0 |
| BSESN-1 | — | 19.5 | 0.611 | 0.389 | 611 | 83.8 |

### Examples 1 to 6

The light emitting devices according to the embodiment shown in FIGS. 3A and 3B were produced.

In the step of disposing a light emitting element, a ceramic substrate formed of aluminum nitride was used as the substrate. A light emitting element on which a nitride-based semiconductor layer having a light emission peak wavelength of 450 nm was laminated was used as the light emitting element. The size of the light emitting element was a substantially square having a planar shape of approximately 1.0 mm square, and the thickness was approximately 0.11 mm. The light emitting element was disposed such that the light emitting surface was on the substrate side and was flip-chip mounted by bumps using conductive members formed of Au. The semiconductor element was flip-chip mounted thereon by bumps using conductive members formed of Au at a distance from the light emitting element.

A silicone resin a (Shore A hardness of 70) was used as the light-transmissive material. In the step of forming a wavelength conversion member including a wavelength conversion body, the first fluorescent material and the second fluorescent material were used in the composition shown in Table 2 relative to 100 parts by mass of the silicone resin a serving as the light-transmissive material. In Table 2, the fluorescent material total amount refers to the total amount of the first fluorescent material and the second fluorescent material relative to 100 parts by mass of the silicone resin a. In Table 2, the first fluorescent material mass ratio (% by mass) and the second fluorescent material mass ratio (% by mass) refer to the mass ratio of the first fluorescent material and the mass ratio of the second fluorescent material, respectively, relative to the total content of the first fluorescent material and the second fluorescent material being 100% by mass. The content of the first fluorescent material or the second fluorescent material contained in the light emitting device can be calculated by dividing the product of the total amount (parts by mass) of the first fluorescent material and the second fluorescent material and the mass ratio (% by mass) of the first fluorescent material and the second fluorescent material by 100. For the light-transmissive body, a light-transmissive body formed of borosilicate glass was prepared, the shape of which was a substantially square having a planar shape of approximately 1.15 mm square, which was approximately 0.15 mm larger in length and width than the planar shape of the light emitting element, and the thickness of which was approximately 0.10 mm. The wavelength conversion body composition was printed on one surface of the light-transmissive body having a substantially square shape by the printing method and cured by heating at 180° C. for 2 hours to form a layered wavelength conversion body having a thickness of approximately 80 μm, thereby forming a wavelength conversion member in which the layered or plate-shaped wavelength conversion body and the light-transmissive body were integrated. In the present specification, the Shore A hardness of the silicone resin was measured using a Durometer Type A (product name: GS-709G, manufactured by TECLOCK Co., Ltd.) according to JIS K6253.

In the step of adhering a light emitting element and a wavelength conversion member, one surface of the wavelength conversion member having a substantially square with a planar shape of approximately 1.15 mm square and one surface of the light emitting element having a substantially square with a planar shape of approximately 1.0 mm square were adhered to each other using an adhesive containing a silicone resin, thereby forming an adhesive layer between the light emitting element and the wavelength conversion member.

In the step of forming a covering member, a covering member composition containing a dimethyl silicone resin and titanium oxide particles, in which the amount of the titanium oxide particles was 30 parts by mass relative to 100 parts by mass of the dimethyl silicone resin, was prepared. The covering member composition was filled such that the lateral surfaces of the light emitting element disposed on the substrate and the wavelength conversion member including the wavelength conversion body and the light-transmissive body were covered with the covering member composition, and the semiconductor element was completely embedded in the covering member composition; and the covering member composition was then cured to form a covering member and a resin package, thereby producing a light emitting device.

### Comparative Example 1

A light emitting device was produced in the same or similar manner as in Example 1, except that YAG-6 having a composition not included in the formula (1A) was used as the first fluorescent material, and the first fluorescent material and the second fluorescent material were used in the composition shown in Table 2.

The resulting light emitting devices were subjected to the following measurements. The results are shown in Table 2.

### Light Emission Spectrum, Chromaticity Coordinates (x, y), and Correlated Color Temperature (K) of Light Emitting Device

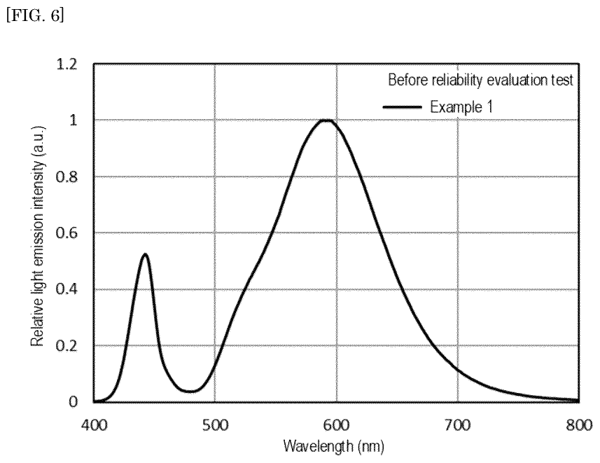

For each light emitting device, the light emission spectrum was measured at room temperature (25° C.±5° C.) using an optical measurement system combining a spectrophotometer (PMA-11, manufactured by Hamamatsu Photonics K.K.) and an integral sphere. The x and y values in the CIE1931 chromaticity coordinates and the correlated color temperature (K) according to JIS Z8725 were measured from the light emission spectrum of each light emitting device. The light emission spectrum of the light emitting device according to Example 1 when the maximum light emission intensity is set to 1 is shown in FIG. 6.

### First Luminance Ratio Ls/L

The light emission spectrum S (λ) measured for each light emitting device, the S-cone spectral sensitivity of humans Gs (λ) obtained from FIG. 1A, and the spectral luminous efficiency curve for photopic vision of humans V (λ) specified by CIE obtained from FIG. 1B were substituted into the formula (1) to determine a first luminance ratio Ls/L of the light emission of each light emitting device.

### Second Luminance Ratio B/A

The light emission spectrum S (λ) measured for each light emitting device and the scattering intensity curve Dc (λ) obtained from FIG. 2 were substituted into the formula (2) to determine a second luminance ratio B/A of the light emission of each light emitting device.

### Relative Luminous Flux (%)

The luminous flux of each light emitting device was measured using a total luminous flux measuring apparatus with an integral sphere. The relative luminous flux of each light emitting device other than Comparative Example 1 was calculated when the luminous flux of the light emitting device according to Comparative Example 1 was set to 100%.

TABLE 2

| | Wavelength conversion composition | | | | | |
|---|---|---|---|---|---|---|
| | | | | | First | Second |
| | | Ce | | Fluorescent | fluorescent | fluorescent |
| | | molar ratio | | material | material | material |
| | First | formula | Second | total amount | mass ratio | mass ratio |
| | fluorescent | (1A) | fluorescent | (parts | (% by | (% by |
| | material | parameter e | material | by mass) | mass) | mass) |
| Example 1 | YAG-1 | 0.025 | BSESN-1 | 2 [symbol] 0 | 81.5 | 18.5 |
| Example 2 | YAG-2 | 0.064 | BSESN-1 | 155 | 7 [symbol] .5 | 23.5 |
| Example 3 | YAG-3 | 0.082 | BSESN-1 | 120 | 76.5 | 23.5 |
| Example 4 | YAG-3 | 0.082 | BSESN-1 | 115 | 91.5 | 8. [symbol] |
| Example 5 | YAG-4 | 0.09 [symbol] | BSESN-1 | 135 | 81.5 | 18.5 |
| Example 6 | YAG-5 | [symbol] .112 | BSESN-1 | 155 | 81.5 | 1 [symbol] .5 |
| Comparative | YAG-6 | 0.018 | BSESN-1 | 275 | 83.0 | 17.0 |
| Example 1 | | | | | | |

| | Light-emitting device | | | | | |
|---|---|---|---|---|---|---|
| | | | First | Second | Correlated | Relative |
| | Chromaticity | | luminance | luminance | color | luminous |
| | coordinates | | ratio | ratio | temperature | flux |
| | x | y | Ls/L | B/A | (K) | (%) |
| Example 1 | 0. [symbol] | 0.413 | 0.61 | 0.076 | 2901.7 | 104.0 |
| Example 2 | 0. [symbol] | 0. [symbol] 8 | 0.63 | 0.077 | 2969.3 | 103.7 |
| Example 3 | 0.43 [symbol] | 0.402 | 0.65 | 0.078 | 2 [symbol] | 102.9 |
| Example 4 | 0. [symbol] | 0.414 | 0. [symbol] 7 | 0.084 | 3 [symbol] .4 | 114.5 |
| Example 5 | 0. [symbol] 9 | 0.419 | 0. [symbol] 0 | 0.074 | 2903.3 | 105.2 |
| Example 6 | 0.441 | 0.4 [symbol] 7 | 0.63 | [symbol] .076 | 2 [symbol] . [symbol] | 1 [symbol] 0.4 |
| Comparative | 0.434 | 0.3 [symbol] | 0. [symbol] | [symbol] | 2 [symbol] 2 | 100.0 |
| Example 1 | | | | | | |

[symbol]

indicates data missing or illegible when filed

The light emitting devices according to Examples 1 to 6 emitted light having a correlated color temperature of 1,800 K or more and 5,000 K or less, and a first luminance ratio Ls/L of 0.9 or less. The light emitting devices according to Examples 1 to 6 emitted light with reduced glare.

The light emitting devices according to Examples 1 to 6 emitted light having a second luminance ratio B/A of 0.104 or less. The light emitting devices according to Examples 1 to 6 emitted light that was suppressed in light scattering and reached a relatively long distance.

The light emitting devices according to Examples 1 to 6 contained a first fluorescent material having a composition represented by the formula (1A); and in the formula (1A), the parameter e representing the molar ratio of Ce as an activating element satisfied the range of 0.019 or more and 0.2 or less (0.019≤e≤0.2), more specifically, the range of 0.025 or more and 0.112 or less, and the content of the first fluorescent material contained in the light emitting device (the amount obtained by dividing the product of the total amount of the fluorescent materials and the mass ratio of the first fluorescent material by 100) was reduced compared to that of the first fluorescent material having a composition not included in the composition formula represented by the formula (1A). In addition, the light emitting devices according to Examples 1 to 6 contained a first fluorescent material having a composition represented by the formula (1A), and in the formula (1A), the parameter e representing the molar ratio of Ce as an activating element satisfied the range of 0.019 or more and 0.2 or less (0.019≤e≤0.2), so that the total amount of the fluorescent materials contained in the wavelength conversion member was also reduced compared to that of the wavelength conversion member used in the light emitting device according to Comparative Example 1, and even when the total amount of the fluorescent materials was small, the light emitting devices emitted light having a color in the desired range of CIE chromaticity coordinates, a first luminance ratio Ls/L of 0.9 or less, and a second luminance ratio B/A of 0.104 or less.

### Reliability Evaluation Test and Quantification of Delamination Rate

The resulting light emitting devices were subjected to a reliability evaluation test. The results are shown in Table 3. For reliability evaluation, each light emitting device was subjected to a reliability evaluation test for 700 hours in an environmental test chamber at 85° C. and 85% relative humidity, repeatedly turned on and off for 30 minutes each at a current of 1,200 mA. After the reliability evaluation test, the wavelength conversion member in the light emitting device was observed using a microscope, and the rate of delamination that occurred between the wavelength conversion body and the light-transmissive body was quantified to evaluate durability. The rate of delamination that occurred between the wavelength conversion body 41 and the light-transmissive body 42 of the wavelength conversion member 40, as shown in FIG. 3B, was quantified.

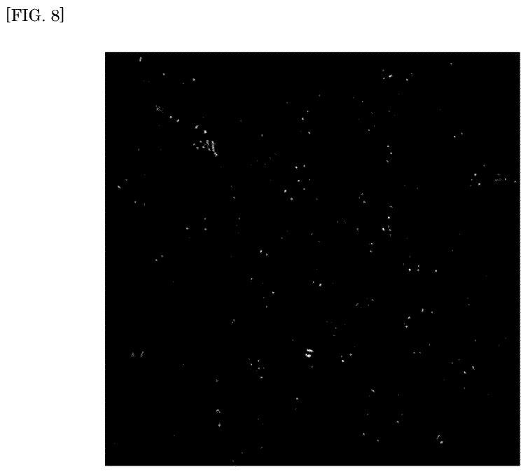

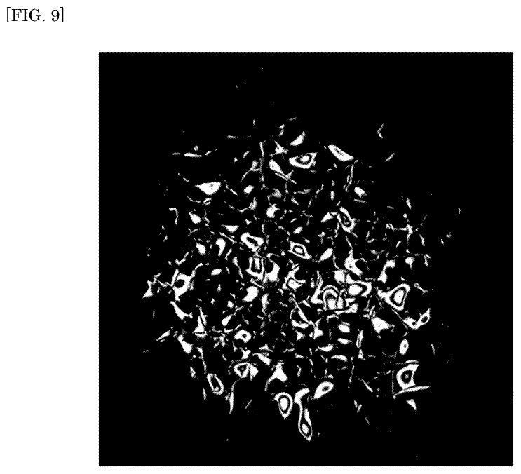

The rate of delamination was quantified using “ImageJ”, an open source, public domain image analysis and processing software developed by the National Institutes of Health. A photograph of the light emitting device taken from the light-transmissive body side using a microscope was cropped to show only the surface of the light-transmissive body, the color photograph taken of the light-transmissive body was separated into the three primary colors RGB, and only G was extracted from the three primary colors RGB. This is because G tends to produce clear and distinct light contrasts (light and dark). The contrast of the photograph in which only G was extracted from the color photograph taken of the light-transmissive body in the light emitting device was adjusted to emphasize and binarize the delaminated areas that occurred between the wavelength conversion body and the light-transmissive body, and the ratio of the total of the delaminated areas on the surface of the light-transmissive body to the area of the entire surface of the light-transmissive body (delaminated surface/light-transmissive body surface (%)) was calculated as the delamination rate. The calculated delamination rate is shown in Table 3. The type of the first fluorescent material represented by the formula (1A) and the molar ratio of Ce contained in the first fluorescent material (parameter e in the formula (1A)), contained in the wavelength conversion member of each light emitting device are also shown in Table 3. The binarized photograph of the surface of the light-transmissive body in the light emitting device according to Example 1 after the 700-hour reliability evaluation test is shown in FIG. 8. The binarized photograph of the surface of the light-transmissive body in the light emitting device according to Comparative Example 1 after the 700-hour reliability evaluation test is shown in FIG. 9.

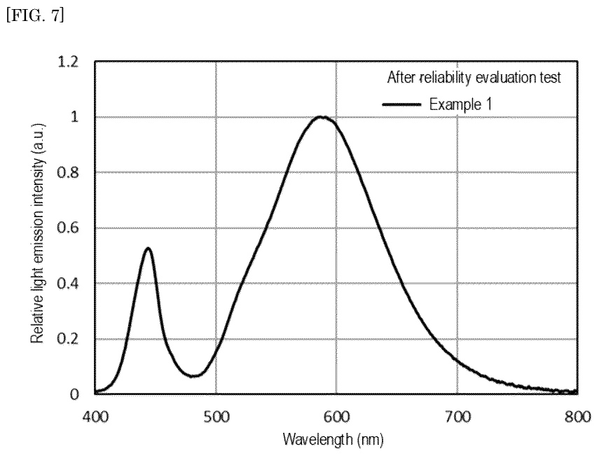

For each light emitting device after the reliability evaluation test described above, the first luminance ratio and the second luminance ratio were calculated in the same or similar manner as before the reliability evaluation test. Also, in the same or similar manner as before the reliability evaluation test, the light emission spectrum of each light emitting device after the reliability evaluation test was measured, and the x and y values in the CIE1931 chromaticity coordinates and the correlated color temperature (K) in accordance with JIS Z8725 were measured from the light emission spectrum of each light emitting device. Specifically, the x and y values in the CIE chromaticity coordinates of the mixed-color light emitted by the light emitting device in its initial state before the reliability evaluation test were defined as x1 and y1 values, the light emitting device was repeatedly turned on and off for 30 minutes each at a current of 1,200 mA in an environmental test chamber at 85° C. and 85% relative humidity for 700 hours, the CIE chromaticity coordinates of the mixed-color light emitted by the light emitting device were then measured as x2 and y2 values, and the absolute values of the difference Δx between the x1 and x2 values and the difference Δy between the y1 and y2 values were calculated. The light emission spectrum of the light emitting device according to Example 1 after the reliability evaluation test described above when the maximum light emission intensity is set to 1 is shown in FIG. 7.

TABLE 3

| | | | Reliability evaluation test (700 hours) | | | | | |
|---|---|---|---|---|---|---|---|---|
| | | | Delamination | | | | | |
| | Wavelength | | rate | | | | | |
| | conversion member | | Delaminated | | | | | |
| | | Ce | surface/light- | First | Second | | | Correlated |
| | First | molar ratio | transmissive | luminance | luminance | | | color |
| | fluorescent | formula (1A) | body surface | ratio | ratio | | | temperature |
| | material | parameter e | (%) | Ls/L | B/A | Δx | Δy | (K) |
| Example 1 | YAG-1 | 0.025 | 0.2 | 0.63 | 0.078 | 0.0037 | 0.0032 | 3074.6 |
| Example 2 | YAG-2 | 0.064 | 0.1 | 0.64 | 0.079 | 0.0022 | 0.0015 | 3101.8 |
| Example 3 | YAG-3 | 0.082 | 0.1 | 0. [symbol] 7 | 0.080 | 0.0022 | 0.0023 | 3100.7 |
| Example 4 | YAG-3 | 0.082 | 1.1 | 0.70 | 0.087 | 0.0017 | 0.0027 | 3874.8 |
| Example 5 | YAG-4 | 0.095 | 0.0 | 0.61 | 0.075 | 0.0023 | 0.0019 | 2994.0 |
| Example 6 | YAG-5 | 0.112 | 0.0 | 0.66 | 0.078 | 0.0028 | 0.0025 | 3041.9 |
| Comparative | YAG-6 | 0.018 | 6.7 | 0.66 | 0.080 | 0.0069 | 0.0082 | 3111.6 |
| Example 1 | | | | | | | | |

[symbol]

indicates data missing or illegible when filed

The light emitting devices according to Examples 1 to 6 emitted light having a correlated color temperature of 1,800 K or more and 5,000 K or less, and a first luminance ratio Ls/L of 0.9 or less, even after the 700-hour reliability evaluation test performed in the environmental test chamber at 85° C. and 85% relative humidity. The light emitting devices according to Examples 1 to 6 emitted light with reduced glare.

The light emitting devices according to Examples 1 to 6 emitted light having a second luminance ratio B/A of 0.104 or less, even after the 700-hour reliability evaluation test performed in the environmental test chamber at 85° C. and 85% relative humidity. The light emitting devices according to Examples 1 to 6 emitted light that was suppressed in light scattering and reached a relatively long distance.

The light emitting devices according to Examples 1 to 6 contained a first fluorescent material having a composition represented by the formula (1A), and in the formula (1A), the parameter e representing the molar ratio of Ce as an activating element satisfied the range of 0.019 or more and 0.2 or less (0.019≤e≤0.2), so that the total amount of the fluorescent materials contained in the wavelength conversion member was reduced compared to that of the wavelength conversion member used in the light emitting device according to Comparative Example 1, and after the 700-hour reliability evaluation test performed in the environmental test chamber at 85° C. and 85% relative humidity, the rate of delamination that occurred between the wavelength conversion body 41 and the light-transmissive body 42 of the wavelength conversion member 40 was lower than that of the light emitting device according to Comparative Example 1, thereby improving durability. In addition, the light emitting devices according to Examples 1 to 6 contained a first fluorescent material having a composition represented by the formula (1A), and in the formula (1A), the parameter e representing the molar ratio of Ce as an activating element satisfied the range of 0.019 or more and 0.2 or less (0.019≤e≤0.2), so that the values of Δx and Δy, which represent the change in chromaticity before and after the reliability evaluation test, were smaller than those of the light emitting device according to Comparative Example 1, thereby suppressing chromaticity deviation and improving durability.

There was almost no change in the light emission spectrum between the light emission spectrum of the light emitting device according to Example 1 before the reliability evaluation test shown in FIG. 6 and the light emission spectrum of the light emitting device according to Example 1 after the reliability evaluation test shown in FIG. 7, indicating that even after the 700-hour reliability evaluation test performed in the environmental test chamber at 85° C. and 85% relative humidity, the light emitting device emitted light that reduced glare, suppressed light scattering, and reached a relatively long distance as described above.

In the binarized photograph of the surface of the light-transmissive body in the light emitting device according to Example 1 after the 700-hour reliability evaluation test shown in FIG. 8, almost no white delaminated areas were observed, indicating that the durability of the light emitting device was improved.

In the binarized photograph of the surface of the light-transmissive body in the light emitting device according to Comparative Example 1 after the 700-hour reliability evaluation test shown in FIG. 9, there were many white areas indicating the delamination between the wavelength conversion body and the light-transmissive body.

### INDUSTRIAL APPLICABILITY

The light emitting device according to the embodiment of the present disclosure can be used for a headlight. The headlight including the light emitting device according to the embodiment of the present disclosure can be used for road transportation vehicles such as motorcycles and automobiles, railway vehicles, and vehicles used for tractor-type construction machines such as ground leveling, transporting, and loading machines, or excavator-type construction machines such as excavating machines.

### EXPLANATIONS OF LETTERS OR NUMERALS

1: Substrate, 10: Light emitting element, 12: Lighting control unit, 22: Outer lens, 24: Lamp body, 26: Optical filter, 28: Screws, 32: Substrates, 34: Light guide member, 40: Wavelength conversion member, 41: Wavelength conversion body, 41a: High-concentration layer, 41b: Low-concentration layer, 42: Light-transmissive body, 50: Semiconductor element, 60: Conductive members, 71: First fluorescent material, 72: Second fluorescent material, 80: Adhesive layer, 90: Covering member, 100, 101: Light emitting device, and 200: Headlight.

What is claimed is:

1. A light emitting device, comprising:
a light emitting element having a light emission peak wavelength in a range of 400 nm or more and 490 nm or less; and
a wavelength conversion member including,
a first fluorescent material having a light emission peak wavelength in a range of 480 nm or more and less than 580 nm and
a second fluorescent material having a light emission peak wavelength in a range of 580 nm or more and 680 nm or less and having a composition different from a composition of the first fluorescent material,
the light emitting device emitting light having a first luminance ratio Ls/L, as derived from the following formula (1), of 0.9 or less,
the first luminance ratio Ls/L being a ratio of a first effective radiance Ls of the light emitted by the light emitting device in a range of 380 nm or more and 780 nm or less in consideration of a spectral luminous efficiency curve for photopic vision of humans specified by CIE (Commission Internationale de l'Eclairage) and an S-cone spectral sensitivity of humans, to a luminance L of the light emitted by the light emitting device in a range of 380 nm or more and 780 nm or less in consideration of the spectral luminous efficiency curve for photopic vision of humans,
the first fluorescent material comprising a rare earth aluminate fluorescent material having a composition represented by the following formula (1A):
$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$
wherein S (λ) represents a spectral radiance of the light emitted by the light emitting device, V (λ) represents a spectral luminous efficiency curve for photopic vision of humans specified by CIE (Commission Internationale de l'Eclairage), and Gs (λ) represents the S-cone spectral sensitivity of humans in a wavelength A range of 380 nm or more and 550 nm or less; and 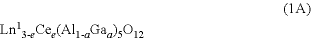
wherein Ln¹ represents at least one element selected from the group consisting of Y, Gd, Tb, and Lu, and a and e satisfy 0≤a≤0.5 and 0.019≤e≤0.2.

2. The light emitting device according to claim 1, wherein the light emitting device emits light having a correlated color temperature of 1,800 K or more and 5,000 K or less.

3. The light emitting device according to claim 1, wherein the first fluorescent material has a light emission spectrum having a full width at half maximum in a range of 90 nm or more and 125 nm or less.

4. The light emitting device according to claim 1, wherein the second fluorescent material has a light emission spectrum having a full width at half maximum in a range of 3 nm or more and 15 nm or less, or a light emission spectrum having a full width at half maximum in a range of 60 nm or more and 120 nm or less.

5. The light emitting device according to claim 1, wherein the rare earth aluminate fluorescent material having a composition represented by the formula (1A) has an average particle diameter, as measured according to a Fisher Sub-Sieve Sizer method, in a range of 15 μm or more and 40 μm or less.

6. The light emitting device according to claim 1, wherein the first fluorescent material comprises a rare earth aluminate fluorescent material having a composition represented by the formula (1A), and further comprises a first nitride fluorescent material having a composition represented by the following formula (1B): 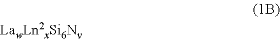
wherein Ln² necessary includes at least one selected from the group consisting of Y and Gd, and may include at least one selected from the group consisting of Sc and Lu, the total of Y and Gd included in Ln² is 90 mol % or more relative to the Ln² elements included in 1 mol of the composition being 100 mol %, and w, x, y, and z satisfy 1.2≤w≤2.2, 0.5≤x≤1.2, 10≤y≤12, 0.5≤z≤1.2, 1.80<w+x<2.40, and 2.9≤w+x+z≤3.1.

7. The light emitting device according to claim 1, wherein the second fluorescent material comprises at least one selected from the group consisting of a second nitride fluorescent material having a composition represented by the following formula (2A), a third nitride fluorescent material having a composition represented by the following formula (2B), a fluoride fluorescent material having a composition represented by the following formula (2C), a fluoride fluorescent material having a composition represented by the following formula (2C′) that is different in composition from the following formula (2C), and an α-SiAlON fluorescent material having a composition represented by the following formula (2G): 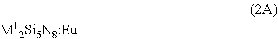
wherein M¹ represents an alkaline earth metal element containing at least one selected from the group consisting of Ca, Sr, and Ba; 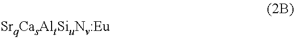
wherein q, s, t, u, and v satisfy 0≤q<1, 0<s≤1, q+s≤1, 0.9≤t≤1.1, 0.9≤u≤1.1, and 2.5≤v≤3.5; 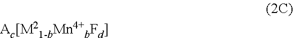
wherein A includes at least one selected from the group consisting of K⁺, Li⁺, Nat, Rb⁺, Cs⁺, and NH₄⁺, M² includes at least one element selected from the group consisting of Group 4 elements and Group 14 elements, b satisfies 0<b<0.2, c represents an absolute value of the charge of [M²_{1-b}Mn⁴⁺_{b}F_{d}] ions, and d satisfies 5<d<7; 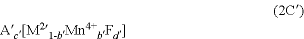
wherein A′ includes at least one selected from the group consisting of K⁺, Li⁺, Na⁺, Rb⁺, Cs⁺, and NH₄⁺, M^{2′} includes at least one element selected from the group consisting of Group 4 elements, Group 13 elements, and Group 14 elements, b′ satisfies 0<b′<0.2, c′ represents an absolute value of the charge of [M^{2′}_{1-b′}Mn⁴⁺_{b′}F_{d′}] ions, and d′ satisfies 5<d′<7; and 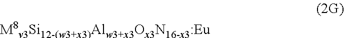
wherein M⁸ includes at least one element selected from the group consisting of Li, Mg, Ca, Sr, Y, and lanthanoid elements (excluding La and Ce), and v3, w3, and x3 satisfy 0<v3≤2.0, 2.0≤w3≤6.0, and 0≤x3≤1.0.

8. The light emitting device according to claim 1, wherein
the wavelength conversion member comprises a wavelength conversion body including the first fluorescent material, the second fluorescent material, and a light-transmissive material, and
a total amount of the first fluorescent material and the second fluorescent material is in a range of 50 parts by mass or more and 500 parts by mass or less relative to an amount of the light-transmissive material in the wavelength conversion body being 100 parts by mass.

9. The light emitting device according to claim 1,
wherein the wavelength conversion member comprises a wavelength conversion body including the first fluorescent material, the second fluorescent material, and a light-transmissive material,
the wavelength conversion body comprises
a high-concentration layer having a high filling ratio of the first fluorescent material and the second fluorescent material, and a low-concentration layer having
a low filling ratio of the first fluorescent material and the second fluorescent material, and
the high-concentration layer is disposed on the light emitting element side.

10. A headlight, comprising the light emitting device according to claim 1.

11. The headlight according to claim 10, comprising two or more types of light emitting devices each having a different value of the first luminance ratio Ls/L.

12. A headlight, comprising two or more types of light emitting devices including a first light emitting device including the light emitting device according to claim 1, and a second light emitting device that emits light having a first luminance ratio Ls/L, as derived from the following formula (1), of more than 0.9, the first luminance ratio Ls/L being a ratio of a first effective radiance Ls of the light emitted by the light emitting device in a range of 380 nm or more and 780 nm or less in consideration of a spectral luminous efficiency curve for photopic vision of humans specified by CIE (Commission Internationale de l'Eclairage) and an S-cone spectral sensitivity of humans, to a luminance L of the light emitted by the light emitting device in a range of 380 nm or more and 780 nm or less in consideration of the spectral luminous efficiency curve for photopic vision of humans:
$$Ls / L = \frac{{\int }_{380}^{780} S ( λ ) \{ 1.26 \times Gs ( λ ) + V ( λ ) \} d λ}{2.3 {\int }_{380}^{780} S ( λ ) \times V ( λ ) d λ} \qquad ( 1 )$$
wherein S (λ) represents a spectral radiance of light emitted by the light emitting device, V (λ) represents a spectral luminous efficiency curve for photopic vision of humans specified by CIE (Commission Internationale de l'Eclairage), and Gs (λ) represents an S-cone spectral sensitivity of humans in a wavelength A range of 380 nm or more and 550 nm or less.

13. A light emitting device, comprising:
a light emitting element having a light emission peak wavelength in a range of 400 nm or more and 490 nm or less; and
a wavelength conversion member including
a first fluorescent material having a light emission peak wavelength in a range of 480 nm or more and less than 580 nm and
a second fluorescent material having a light emission peak wavelength in a range of 580 nm or more and 680 nm or less and having a composition different from a composition of the first fluorescent material,
the light emitting device emitting light having a second luminance ratio B/A, as derived from the following formula (2), of 0.104 or less,
the second luminance ratio B/A being a ratio of a second effective radiance B of light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less, the first fluorescent material comprising a rare earth aluminate fluorescent material having a composition represented by the following formula (1A):
$$B / A = \frac{{\int }_{300}^{800} Dc ( λ ) \times S ( λ ) d λ}{{\int }_{300}^{800} S ( λ ) d λ} \qquad ( 2 )$$
wherein S (λ) represents a spectral radiance of the light emitted by the light emitting device, and Dc (λ) denotes a scattering intensity curve, normalized to 1 at a wavelength of 300 nm for Rayleigh scattering; and 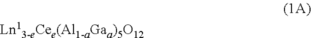
wherein Ln¹ represents at least one element selected from the group consisting of Y, Gd, Tb, and Lu, and a and e satisfy 0≤a≤0.5 and 0.019≤e≤0.2.

14. The light emitting device according to claim 13, wherein the emitting device emits light having a correlated color temperature of 1,800 K or more and 5,000 K or less.

15. The light emitting device according to claim 13, wherein the first fluorescent material has a light emission spectrum having a full width at half maximum in a range of 90 nm or more and 125 nm or less.

16. The light emitting device according to claim 13, wherein the second fluorescent material has a light emission spectrum having a full width at half maximum in a range of 3 nm or more and 15 nm or less, or a light emission spectrum having a full width at half maximum in a range of 60 nm or more and 120 nm or less.

17. The light emitting device according to claim 13, wherein the first fluorescent material comprises a rare earth aluminate fluorescent material having a composition represented by the formula (1A), and further comprises a first nitride fluorescent material having a composition represented by the following formula (1B): 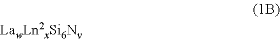
wherein Ln² necessary includes at least one selected from the group consisting of Y and Gd, and may include at least one selected from the group consisting of Sc and Lu, the total of Y and Gd included in Ln² is 90 mol % or more relative to the Ln² elements included in 1 mol of the composition being 100 mol %, and w, x, y, and z satisfy 1.2≤w≤2.2, 0.5≤x≤1.2, 10<y≤12, 0.5≤z≤1.2, 1.80<w+x<2.40, and 2.9≤w+x+z≤3.1.

18. The light emitting device according to claim 13, wherein the second fluorescent material comprises at least one selected from the group consisting of a second nitride fluorescent material having a composition represented by the following formula (2A), a third nitride fluorescent material having a composition represented by the following formula (2B), a fluoride fluorescent material having a composition represented by the following formula (2C), a fluoride fluorescent material having a composition represented by the following formula (2C′) that is different in composition from the following formula (2C), and an α-SiAlON fluorescent material having a composition represented by the following formula (2G): 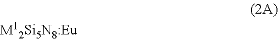
wherein M¹ represents an alkaline earth metal element containing at least one selected from the group consisting of Ca, Sr, and Ba; 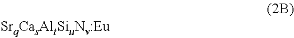
wherein q, s, t, u, and v satisfy 0≤q<1, 0<s≤1, q+s≤1, 0.9≤t≤1.1, 0.9≤u≤1.1, and 2.5≤v≤3.5; 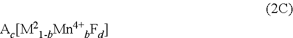
wherein A includes at least one selected from the group consisting of K⁺, Li⁺, Na⁺, Rb⁺, Cs⁺, and NH₄⁺+, M² includes at least one element selected from the group consisting of Group 4 elements and Group 14 elements, b satisfies 0<b<0.2, c represents an absolute value of the charge of [M²_{1-b}Mn⁴⁺_{b}F_{d}] ions, and d satisfies 5<d<7; 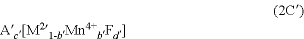
wherein A′ includes at least one selected from the group consisting of K⁺, Li⁺, Na⁺, Rb⁺, Cs⁺, and NH₄⁺, M^{2′} includes at least one element selected from the group consisting of Group 4 elements, Group 13 elements, and Group 14 elements, b′ satisfies 0<b′<0.2, c′ represents an absolute value of the charge of [M^{2′}_{1-b′}Mn⁴⁺_{b′}F_{d′}] ions, and d′ satisfies 5<d′<7; and 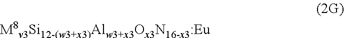
wherein M⁸ includes at least one element selected from the group consisting of Li, Mg, Ca, Sr, Y, and lanthanoid elements (excluding La and Ce), and v3, w3, and x3 satisfy 0<v3≤2.0, 2.0≤w3≤6.0, and 0≤x3≤1.0.

19. The light emitting device according to claim 13, wherein the rare earth aluminate fluorescent material having a composition represented by the formula (1A) has an average particle diameter, as measured according to a Fisher Sub-Sieve Sizer method, in a range of 15 μm or more and 40 μm or less.

20. The light emitting device according to claim 13, wherein
the wavelength conversion member comprises a wavelength conversion body including the first fluorescent material, the second fluorescent material, and a light-transmissive material, and
a total amount of the first fluorescent material and the second fluorescent material is in a range of 50 parts by mass or more and 500 parts by mass or less relative to an amount of the light-transmissive material in the wavelength conversion body being 100 parts by mass.

21. The light emitting device according to claim 13,
wherein the wavelength conversion member comprises a wavelength conversion body including the first fluorescent material, the second fluorescent material, and a light-transmissive material,
the wavelength conversion body comprises
a high-concentration layer having a high filling ratio of the first fluorescent material and
the second fluorescent material, and a low-concentration layer having a low filling ratio of the first fluorescent material and the second fluorescent material, and
the high-concentration layer is disposed on the light emitting element side.

22. A headlight, comprising the light emitting device according to claim 13.

23. The headlight according to claim 22, comprising two or more types of light emitting devices each having a different value of the second luminance ratio B/A.

24. A headlight, comprising two or more types of light emitting devices including
a first light emitting device including the light emitting device according to claim 13, and
a second light emitting device that emits light having a second luminance ratio B/A, as derived from the following formula (2), of more than 0.104, the second luminance ratio B/A being a ratio of a second effective radiance B of the light emitted by the light emitting device in a range of 300 nm or more and 800 nm or less in consideration of a scattering intensity curve for wavelengths when a scattering intensity of Rayleigh scattering at a wavelength of 300 nm is 1, to a radiance A of the light emitted by the light emitting device in a range of 300 nm or more and 800 nm or less:
$$B / A = \frac{{\int }_{300}^{800} Dc ( λ ) \times S ( λ ) d λ}{{\int }_{300}^{800} S ( λ ) d λ} \qquad ( 2 )$$
wherein S (λ) represents a spectral radiance of the light emitted by the light emitting device, and Dc (λ) denotes a scattering intensity curve, normalized to 1 at a wavelength of 300 nm for Rayleigh scattering.

25. A vehicle, comprising the light emitting device according to claim 1.

26. A vehicle, comprising the headlight emitting device according to claim 13.

27. A vehicle, comprising the headlight according to claim 10.

28. A vehicle, comprising the headlight according to claim 22.
